(19) United States
(12) Patent Application Publication
(10) Pub. No.: US 2026/0184893 A1
(43) Pub. Date: Jul. 2, 2026

(54) ORGANIC FILLERS WITH THIOETHER LINKAGES

(71) Applicant: Suncoal Industries GmbH, Ludwigsfelde (DE)

(72) Inventors: Priyanka Sekar, Ludwigsfelde (DE); Jacob Podschun, Ludwigsfelde (DE); Gerd Schmaucks, Ludwigsfelde (DE); Alexander Stücker, Ludwigsfelde (DE); Anke Blume, Weilerswist (DE); Auke Gerardus Talma, Bathmen (NL)

(73) Assignee: Suncoal Industries GmbH, Ludwigsfelde (DE)

(21) Appl. No.: 19/129,578

(22) PCT Filed: Nov. 17, 2023
(86) PCT No.: PCT/EP2023/082210

§ 371 Date: May 13, 2025

(30) Foreign Application Priority Data
Nov. 18, 2022 (EP) 22208442.8

(51) Int. Cl. C08K 5/372; C08K 3/22

(52) U.S. Cl. CPC C08K 5/372; C08K 3/22; C08K 2003/2296

(57) ABSTRACT

An organic filler has a ¹⁴C-content in a range of from 0.20 to 0.45 Bq/g of carbon and has a BET surface area in a range of 10 to <200 m²/g. At least a part of the aliphatic hydroxyl groups present in the chemical structure of the organic filler are substituted with a covalently bonded sulfur atom(s)-containing organic residue, wherein at least one sulfur atom within said organic residue is adjacent to a carbon atom, such that aliphatic carbon-sulfur-carbon linkages in the chemical structure of the organic filler are formed and are present.

The present invention relates to organic fillers producible from renewable materials, to (vulcanizable) rubber compositions comprising besides at least one rubber as filler component, to vulcanized rubber compositions obtainable therefrom, as well as to a use of the aforementioned organic fillers for the production of (vulcanizable) rubber compositions and to a use of such rubber compositions for the production of tires and/or technical rubber articles.

### BACKGROUND OF THE INVENTION

The use of reinforcing fillers in rubber compositions is known in the prior art. In particular, industrial carbon blacks such as furnace carbon blacks are used for this purpose. Industrial carbon blacks still represent the largest quantity of reinforcing fillers. Industrial carbon blacks are produced on the basis of highly aromatic petrochemical oils by means of incomplete combustion or by pyrolysis of hydrocarbons. From an environmental point of view, however, it is desirable to avoid or minimize the use of fossil fuels for the production of fillers. Particularly unfavorable from an environmental point of view is the fact that for the production of one ton of industrial carbon black about one ton of carbon dioxide is released in the production process, depending on the specific surface area of the carbon black. In addition, industrial carbon blacks often cannot be used for certain applications, also for color reasons.

A well-known alternative to the use of industrial carbon blacks as inorganic reinforcing fillers is (precipitated) silica. Chemically modified precipitated silicas are particularly suitable for use as reinforcing fillers due to their high specific surface area.

In the tire industry, the use of corresponding chemically modified and in particular silanized precipitated silicas is also advantageous. Vehicle tires, such as pneumatic tires, have a complex structure and are subject to diverse requirements. On the one hand, short braking distances must be ensured on dry and wet road surfaces, and on the other hand, good abrasion properties and low rolling resistance are to be achieved as well. In addition, the vehicle tires must comply with legal requirements. To ensure the diverse performance profile, the individual tire components are specialized and consist of a variety of different materials, such as metals, polymer textile materials and various rubber-based components. The tread is largely responsible for the driving characteristics. The rubber composition of the tread determines the abrasion behavior and the dynamic driving characteristics in different weather conditions (on wet and dry roads, in cold and warm weather, on ice and snow). The tread design, in turn, is largely responsible for the tire's behavior in aquaplaning and wet conditions, as well as on snow, and also determines the noise development when driving.

In tire tread rubber compounds for passenger cars, the use of silanized precipitated silicas as reinforcing fillers compared with industrial carbon blacks improves rolling resistance due to a chemical bond between the precipitated silicic acid and the elastomer of the rubber compound, and at the same time improves wet grip due to the polarity on the surface of the precipitated silicas. Although tire abrasion is generally worse when precipitated silica is used compared with industrial carbon blacks, this can be counteracted by suitable selection of the elastomers used (e.g., by using polybutadiene).

In tire tread rubber compounds for use in the truck sector, however, the use of silanized precipitated silicas as reinforcing fillers does not achieve the required abrasion resistance to industrial carbon blacks, especially since the aforementioned flexibility in the choice of elastomers, as in the case of passenger car tires, is not available here, since natural rubbers are predominantly used for truck treads.

Another disadvantage of the use of chemically modified and, in particular, silanized precipitated silicas in rubber compositions, especially for the production of tire treads in both the passenger car and truck sectors, is that stress values are lower when small deformations occur than when industrial carbon blacks are used. This is particularly evident in the case of dynamic cyclic deformations that can occur. In order to adjust special tire properties for driving dynamics, the additional use of industrial carbon blacks is therefore necessary, but this is undesirable for the reasons mentioned above.

Moreover, both in the field of technical rubber goods and in the tire industry, rubber compounds are often used in which the specific surface areas of the precipitated silica used are comparatively high, for example in a range of 100 to 250 m²/g (BET surface areas). Although less heat is emitted during mechanical deformation when used in passenger car treads (hysteresis), which improves rolling resistance, an advantage over industrial carbon blacks, which usually have a much lower specific surface area in the range of BET 30 to 50 m²/g, is then often no longer apparent. In addition, there is often a lower dynamic stiffness observed compared to rubber compounds containing industrial carbon blacks as reinforcing fillers.

Lignin-based biologically renewable raw materials, such as lignins in hydrothermally carbonized form (HTC lignin), are also used as organic fillers in rubber compositions. These represent an environmentally friendly filler alternative compared to inorganic fillers and industrial carbon blacks.

EP 3 470 457 A1 describes rubber compounds containing HTC lignin. The disadvantage of using such HTC lignins in rubber compositions, however, is often that the compatibility between the comparatively polar HTC lignins and the comparatively non-polar rubbers is often too low or insufficient. In addition, disadvantages are often observed with regard to the aging resistance and long-term stability of the HTC lignin-containing rubber compositions, also and especially in vulcanized form, because undesirable reactions can occur due to an excessively high proportion of free OH groups contained in the HTC lignins, which have a detrimental effect on aging resistance and long-term stability.

In the field of the production of rubber compositions for use in tires in general, among other application fields, WO 2017/085278 A1 discloses the use of particulate carbon material, in particular also of HTC lignin, as a substitute filler for industrial carbon blacks. The same often occurring disadvantages mentioned above in connection with EP 3 470 457 A1 are associated with this. WO 2017/085278 A1 also describes that this material, after incorporation into a rubber composition, can be subjected to in situ modification with organosilanes as coupling reagents. However, a disadvantage of using such organosilanes to modify carbon materials as described in WO 2017/085278 A1 is often that the thermodynamic stability of the chemical Si—O—C bond formed between materials and organosilane coupling reagents is comparatively low, this bond may therefore be comparatively easy to hydrolyze, and thus undesirable decoupling reactions and thus lower filler-rubber interaction may occur within the rubber composition, which is to be avoided as this may result in deteriorated properties of the rubber composition during and after vulcanization. In addition, the coupling efficiency of the aforementioned carbon materials and organosilane coupling reagents is often too low, since there is often an undesirably high proportion of self-condensation reactions of the organosilanes used, which are then no longer available for the actual modification. A further disadvantage results from the in situ implementation of the modification only within the rubber composition produced, since this often limits to an undesirable extent the degrees of freedom in the production of the composition and the constituents contained therein, especially when the aforementioned carbon materials are used in combination with other fillers such as, in particular, inorganic fillers such as silicas/silica. Another disadvantage is that the in situ reaction with organosilanes requires an additional mixing stage compared to the use of industrial carbon black, which for cost reasons is generally not used in the production of technical rubber articles and most tire components (e.g. sidewall, inner liner).

Finally, WO 2017/194346 A1 also describes the use of HTC lignins in rubber compounds for pneumatic tire components, in particular together with a methylene donor compound such as hexa (methoxymethyl) melamine, to increase the stiffness of a cured rubber component of a pneumatic tire, and among other things to replace phenolic resins. WO 2017/194346 A1 also mentions a possible in situ modification with organosilanes as coupling reagents. However, the same disadvantages mentioned above in connection with WO 2017/085278 A1 are associated with this.

There is therefore a need for new organic fillers suitable for incorporation into rubber compositions, as well as for such rubber compositions per se that do not have the above-mentioned disadvantages.

### Problem

It has been therefore an objective underlying the present invention to provide environmentally friendly fillers, which are suitable directly as such for incorporation into rubber compositions, in particular to provide tire components such as tire treads and tire components for the tire substructure (carcass) and/or to provide components for technical rubber goods, in particular in view to improving the aging resistance and long-term stability of the rubber compositions, even in vulcanized form, increased media resistance and hydrolysis resistance compared with the fillers of the prior art, and improved mechanical properties such as moduli, tensile strength and elongation at break. Furthermore, it is an objective of the present invention to provide corresponding rubber compositions as such containing these fillers.

### Solution

This objective has been solved by the subject-matter of the claims of the present application as well as by the preferred embodiments thereof disclosed in this specification, i.e., by the subject matter described herein.

A first subject-matter of the present invention is an organic filler with a ¹⁴C-content in a range of 0.20 to 0.45 Bq/g of carbon and having a BET surface area in a range of 10 to <200 m²/g,
characterized in that at least a part of the hydroxyl groups being present in the chemical structure of the organic filler, which are bonded to at least one aliphatic carbon atom, has been substituted with a covalently bonded sulfur atom(s)-containing organic residue, wherein at least one sulfur atom is adjacent to a carbon atom within said organic residue, such that aliphatic carbon-sulfur-carbon linkages in the chemical structure of the organic filler have been formed and are present.

Aliphatic carbon-sulfur-carbon linkages are present in the chemical structure of the organic filler, i.e., C_{aliphatic}—S—C-linkages. The aliphatic carbon atom (C_{aliphatic}) of such a linkage corresponds to the at least one aliphatic carbon atom present in the chemical structure of the organic filler, to which a hydroxyl group was bonded. The sulfur atom(S) of such a linkage corresponds to a sulfur atom being present in the sulfur atom-containing organic residue and is covalently bonded to the aforementioned aliphatic carbon atom (C_{aliphatic}) within the chemical structure of the organic filler according to the present invention. The sulfur atom is also covalently bonded to the other carbon atom (C) of such a linkage, which corresponds to the carbon atom being positioned adjacently to the sulfur atom within the sulfur atom-containing organic residue. Said other carbon atom is, hence, different from the aforementioned aliphatic carbon atom. The C_{aliphatic}—S—C-linkages present in the chemical structure of the organic filler represent thioether linkages.

A further subject-matter of the present invention is a rubber composition comprising at least one rubber and at least one filler component,
wherein the filler component comprises at least one organic filler as defined hereinbefore and hereinafter,
and/or
wherein the filler component comprises (i) at least one organic filler precursor FPM having a ¹⁴C content in a range of from 0.20 to 0.45 Bq/g carbon, having a BET surface area in a range of 10 to <200 m²/g, and having at least one hydroxyl group bonded to at least one aliphatic carbon atom, and (ii) at least one organic modification agent, which comprises at least one thiol group being positioned adjacently to a carbon atom within its chemical structure, by means of which a covalent bond to the at least one organic filler precursor FPM can be formed through at least partial substitution of the hydroxyl groups being present in the chemical structure of the organic filler precursor FPM, which are bonded to at least one aliphatic carbon atom, with a covalently bonded sulfur atom(s)-containing organic residue such that aliphatic carbon-sulfur-carbon linkages in the chemical structure of the organic filler are generated, wherein at least one sulfur atom present therein originates from the thiol group of the organic modification agent (ii), and an organic filler as defined hereinbefore and hereinafter is formed.

A further subject-matter of the present invention is a vulcanizable rubber composition comprising the rubber composition as defined hereinbefore and hereinafter and a vulcanization system, preferably comprising at least zinc oxide and/or at least sulfur or a sulfur donor and/or at least one peroxide, particularly preferably comprising at least sulfur.

A further subject-matter of the present invention is a kit-of-parts comprising, in spatially separated form, a rubber composition as part (A) as defined hereinbefore and hereinafter and a vulcanization system as part (B) as defined hereinbefore and hereinafter.

A further subject-matter of the present invention is a vulcanized rubber composition which is obtainable by vulcanizing the vulcanizable rubber composition as defined hereinbefore and hereinafter or by vulcanizing a vulcanizable rubber composition obtainable by combining and mixing the two parts (A) and (B) of the kit-of-parts as defined hereinbefore and hereinafter.

A further subject-matter of the present invention is a use of the organic filler as defined hereinbefore and hereinafter for the production of rubber compositions and vulcanizable rubber compositions and of the rubber composition as defined hereinbefore and hereinafter for the production of tires, preferably pneumatic tires and solid tires, in particular pneumatic tires, preferably in each case for their tread, sidewall and/or inner liner, and/or for the production of technical rubber articles, preferably profiles, seals, dampers and/or hoses.

It was found that the organic filler according to the invention is an environmentally friendly alternative to known fillers of the prior art, in particular to inorganic fillers such as silicas and to carbon blacks for rubber applications.

It was further surprisingly found that the organic filler according to the invention is directly suitable as such for incorporation into rubber compositions, in particular for producing treads, sidewalls and/or inner liners of tires such as pneumatic tires and solid tires, and/or for producing technical rubber articles such as profiles, seals, dampers and/or hoses.

In addition, it was surprisingly found that the organic filler according to the invention has good compatibility with rubbers present in rubber compositions. In particular, it has been found that due to the presence of the covalently bonded sulfur atom(s)-containing organic residue including the resulting aliphatic carbon-sulfur-carbon linkages in the chemical structure of the organic filler, i.e., by the performed surface modification of the filler, a decrease in the polarity of the filler can be achieved to such an extent that the compatibility to the comparatively non-polar rubbers is improved. In particular, it has been shown that the compatibility can be further improved due to the presence of the covalently bonded sulfur atom(s)-containing organic residue including the resulting aliphatic carbon-sulfur-carbon linkages in the chemical structure of the organic filler if the covalently bonded sulfur atom(s)-containing organic residue further comprises at least one reactive functional group, which—when the filler is used together with at least one rubber within a rubber composition—has a reactivity towards the at least one rubber and/or towards at least one functional group of this rubber and/or towards the vulcanization system used, in particular during vulcanization. In this case, bonding of the filler to the rubber and/or the vulcanization system is also possible at the latest during vulcanization, which, in addition to improved compatibility, further improves in particular the reinforcing properties (such as moduli, elongation at break, hysteresis, tear resistance and/or tensile strength) of the vulcanized composition.

Moreover, it was surprisingly found that if the covalently bonded sulfur atom(s)-containing organic residue comprises at least one reactive functional group, which is able to undergo crosslinking reactions with a further identical reactive functional group, such as in case of alkoxysilyl groups as reactive functional groups, which have a reactivity towards each other, and if at least two of such covalently bonded sulfur atom(s)-containing organic residues are present in the chemical structure of the organic filler, (transversal) crosslinking reactions can be observed, which allow a further modification of the surface of the organic filler. In this manner materials with desired and/or tailor-made properties can be produced in a targeted manner, e.g., by modulating the surface porosity and/or density and/or the adhesive or cohesive properties of the filler and/or its surface.

Furthermore, it was surprisingly found that the organic filler according to the invention enables an improvement of the aging resistance and long-term stability of the rubber compositions also in vulcanized form. In this context, it was surprisingly found that the organic filler according to the invention exhibits, in particular, increased media resistance, especially to bases, and hydrolysis resistance compared to fillers of the prior art. In particular, it was found that due to the presence of the covalently bonded sulfur atom(s)-containing organic residue including the resulting aliphatic carbon-sulfur-carbon linkages in the chemical structure of the organic filler, i.e., by the surface modification of the filler, not only the aforementioned compatibility could be improved, but also the proportion of aliphatic OH-groups could be lowered to such an extent that, with the aid of these groups, potentially occurring undesirable reactions which adversely affect the aging resistance and long-term stability could be prevented or at least reduced. In this context, it was found in particular that the susceptibility to hydrolysis of the filler according to the invention could at least be reduced due to the surface modification carried out and that the media resistance, in particular to bases, could be increased. This also further improves the reinforcing properties of the vulcanized composition.

Furthermore, it was surprisingly found that the covalent modification, i.e., introduction of the covalently bonded sulfur atom-containing organic residue, to a suitable filler precursor (i.e., the filler FPM described below) can be carried out in a separate step (“ex situ”) and thus does not necessarily require an in situ bonding within the rubber composition in the presence of a rubber. This has the particular advantage that the already modified organic filler according to the invention can be used specifically as such in rubber compositions as a filler, in particular also in combination with other fillers such as inorganic fillers, especially with (unmodified) silica, and in particular if a modification of the other fillers such as silica with suitable modifiers such as organosilanes is envisaged within the rubber compositions and such modification must therefore still be carried out in situ. The “ex situ” modification thus allows the user more degrees of freedom and flexibility in the preparation and formulation of rubber compositions and the ingredients contained therein.

In addition, it was surprisingly found that due to the presence of the covalently bonded sulfur atom-containing organic residue thermodynamically stable covalent C—S—C-bonds are present in the chemical structure of the filler, having a higher thermodynamic stability than corresponding Si—O—C bonds formed, for example, when non-functional organosilanes are used. This also results in increased hydrolysis resistance, and undesirable decoupling reactions and thus lower filler-rubber interactions within the rubber composition can be avoided or at least reduced. In addition, the use of the modifier according to the invention has the advantage that a high coupling efficiency is achieved, since self-condensation reactions, as may occur when, e.g., non-thiol-groups(s) containing organosilanes are used, do not occur.

It was also surprisingly found that corresponding rubber compositions, in particular vulcanizable rubber compositions, containing the organic filler according to the invention can be used for the manufacture of tires such as pneumatic tires and solid tires, in particular pneumatic tires, preferably in each case for their tread, sidewalls and/or inner liners, and meet the requirements necessary for this purpose to a very high degree, in particular with regard to rolling resistance, abrasion and wet slippage and a balance of these requirements. Similarly, it was surprisingly found that corresponding rubber compositions, in particular vulcanizable rubber compositions, containing the organic filler according to the invention are suitable for use in the manufacture of technical rubber goods (rubber articles), in particular profiles, seals, dampers and/or hoses.

It was also found, surprisingly, that the vulcanized rubber compositions according to the invention have improved mechanical properties, in particular in terms of tensile strength, Shore A hardness and rebound elasticity, compared to vulcanized rubber compositions containing organic fillers not bearing the sulfur-containing linkages, which are present in the chemical structure of the organic filler according to the present invention.

It was also found, particularly surprisingly, that rubber compositions according to the invention, in particular vulcanizable rubber compositions containing the organic filler according to the invention, result in vulcanized rubber compositions characterized by increased moduli in the range up to 200% of elongation. This was found, in particular, even when no industrial carbon blacks were used as additional fillers.

It was also found, in particular surprisingly, that rubber compositions according to the invention, in particular vulcanizable rubber compositions containing the organic filler according to the invention, lead to vulcanized rubber compositions for use as tire treads in the passenger car and in particular in the truck sector which, compared with vulcanized rubber compositions containing silanized precipitated silica instead of the organic filler according to the invention, lead to an improvement in rolling resistance and wet grip with at least acceptable tire abrasion at the same time.

### DETAILED DESCRIPTION OF THE INVENTION

The term “comprising” as used in the present invention in connection with, for example, the rubber compositions according to the invention, the vulcanizable rubber compositions according to the invention, and the process steps or stages in the context of processes described herein preferably has the meaning “consisting of”. In this context, for example, with respect to the rubber compositions according to the invention and the vulcanizable rubber compositions according to the invention-in addition to the constituents necessarily present therein-one or more of the further constituents optionally contained below may also be contained therein. All constituents may be present in their respective preferred embodiments mentioned below. With regard to the processes according to the invention and described herein, these may have further optional process steps and stages in addition to the mandatory steps and/or stages.

The amounts of all the ingredients contained in the compositions described herein, such as the rubber compositions according to the invention and the vulcanizable rubber compositions according to the invention (comprising in each case all the mandatory ingredients and, in addition, all the optional ingredients), add up in each case to 100% by weight.

Organic Filler with Thioether Linkages

As outlined hereinbefore a first subject-matter of the present invention is an organic filler with a ¹⁴C-content in a range of from 0.20 to 0.45 Bq/g of carbon and having a BET surface area in a range of 10 to <200 m²/g,
characterized in that at least a part of the hydroxyl groups being present in the chemical structure of the organic filler, which are bonded to at least one aliphatic carbon atom, has been substituted with a covalently bonded sulfur atom(s)-containing organic residue, wherein at least one sulfur atom within said organic residue is positioned adjacently to a carbon atom, such that aliphatic carbon-sulfur-carbon linkages in the chemical structure of the organic filler have been formed and are present.

The skilled person is familiar with the term filler and in particular with the term organic filler. Preferably, the organic filler according to the invention is a reinforcing filler, i.e., an active filler. Reinforcing or active fillers, in contrast to inactive (non-reinforcing) fillers, can change the viscoelastic properties of a rubber by interacting with a rubber within a rubber composition. For example, they can influence the viscosity of the rubber and can improve the fracture behavior of the vulcanizates, for example in terms of tear propagation resistance, and abrasion. Inactive fillers, on the other hand, dilute the rubber matrix.

Since the filler according to the invention is organic, inorganic fillers such as precipitated silicas are not covered by this term.

The organic filler according to the invention has a ¹⁴C content in the range from 0.20 to 0.45 Bq/g, preferably from 0.23 to 0.42 Bq/g, carbon. The required ¹⁴C content given above is fulfilled by organic fillers obtained from biomass by further treatment or conversion, preferably fractionation, of the same, wherein the fractionation may be thermal, chemical and/or biological, preferably thermal and/or chemical. Fillers obtained from fossil materials, such as in particular fossil fuels, are thus not covered by the definition of filler to be used according to the present invention, since they do not have a corresponding ¹⁴C-content.

“Biomass” is defined herein as any biomass, the term “biomass” herein comprising so-called phytomass, i.e. biomass originating from plants, biomass originating from animals, and microbial biomass, i.e. biomass originating from microorganisms including fungi, the biomass being dry biomass or fresh biomass and originating from dead or living organisms. The biomass particularly preferred herein for the production of the organic fillers, is phytomass, preferably dead phytomass. Dead phytomass includes, but is not limited to, dead, dead or detached plants and components. These include, for example, broken and torn leaves, cereal stalks, side shoots, twigs and branches, fallen foliage, felled or pruned trees, and seeds and fruits and components derived therefrom, as well as sawdust, and other products derived from wood processing.

Preferably, the organic filler according to the invention has a carbon content in the range from 60 wt. % to 85 wt. %, more preferably from 63 wt. % to 80 wt. % and very particularly preferably from 65 wt. % to 75 wt. %, especially from 68 wt. % to 73 wt. %, based in each case on the ash-free and anhydrous filler. A method for determining the carbon content is given below in the methods section. This distinguishes the organic filler in particular both from carbon blacks produced from fossil raw materials and from carbon blacks produced from renewable raw materials, since carbon blacks have a corresponding carbon content of at least 95% by weight.

Preferably, the organic fillers according to the invention have an oxygen content in the range of 15 wt. % to 30 wt. %, preferably 17 wt. % to 28 wt. % and particularly preferably 20 wt. % to 25 wt. %, based on the ash-free and anhydrous filler. The oxygen content can be determined by high-temperature pyrolysis, for example with the aid of the EuroEA3000 CHNS-O Analyzer from EuroVector S.p.A.

The organic filler according to the invention has a BET surface area (total specific surface area according to Brunauer, Emmett and Teller) in a range from 10 to <200 m²/g. A method for determining this parameter is described below in the methods section. Particularly preferably, the organic filler according to the invention has a BET surface area in a range from 10 to 150 m²/g, most preferably a BET surface area in a range from 20 to 120 m²/g, even more preferably a BET surface area in a range from to 110 m²/g, in particular a BET surface area in a range from 40 to 100 m²/g, most preferably a BET surface area in a range from 40 to <100 m²/g.

The organic filler according to the invention preferably has an STSA surface area in a range of 10 to <200 m²/g. A method for determining the STSA surface area (Statistical Thickness Surface Area) is given below in the methods section. Preferably, the organic filler according to the invention has an STSA surface area in a range from 10 to 150 m²/g, particularly in a range from 20 to 120 m²/g, most preferably in a range from 30 to 110 m²/g, especially one in a range from 40 to 100 m²/g, most preferably in a range from 40 to <100 m²/g.

Preferably, the organic filler according to the invention exhibits only conditional solubility in alkaline media, in particular in 0.1 M or 0.2 M NaOH. The solubility is determined according to the method described below. Preferably, the solubility of the organic filler is less than 30%, more preferably less than 25%, most preferably less than 20%, even more preferably less than 15%, even more preferably less than 10%, further preferably less than 7.5%, even more preferably less than 5%, even more preferably less than 2.5%, especially preferably less than 1%.

Preferably, the organic filler is a lignin-based filler, more preferably a lignin-based filler obtainable by means of hydrothermal treatment (HTT). Lignin-based fillers obtained by hydrothermal treatment are also referred to in the following as HTT lignins (“hydrothermally treated lignins”). In the literature, the term HTC lignin (“hydrothermally carbonized lignin”) is also frequently used. Fillers designated as HTC lignins also fall under the term HTT lignins. Hydrothermal treatment at temperatures between 150° C. and 250° in the presence of liquid water is also referred to as hydrothermal treatment in the following. Preferably, the organic filler according to the invention is a lignin-based organic filler produced from biomass and/or biomass components. For example, the lignin for the production of the lignin-based organic filler-prior to its modification according to the invention-can be isolated, extracted and/or dissolved from biomass. Suitable processes for obtaining the lignin for the production of the lignin-based organic filler from biomass are, for example, hydrolysis processes or digestion processes such as the Kraft digestion process. The term “lignin-based” in the context of the present invention preferably means that one or more lignin units and/or one or more lignin scaffolds are present in the organic filler according to the invention. Lignins are solid biopolymers which are incorporated into plant cell walls and thus cause lignification of plant cells. They are therefore present in biomass and in particular in biologically renewable raw materials and therefore represent-especially in hydrothermally treated form—an environmentally friendly filler alternative.

Due to their natural origin, lignins are structurally non-uniform phenolic biopolymers composed of different monomer building blocks that vary structurally depending on their plant origin. In particular, the molecular structure of lignin comprises inter alia a number of different aliphatic OH-groups. It has now been found that these can be used to introduce to covalently bind sulfur atom(s)-containing organic residues to the aliphatic carbon atoms of such groups, in particular by a substitution reaction making use of organic thiols as organic modification agents.

Preferably, the organic filler according to the invention is a lignin-based organic filler with a lignin content of at least 50% by weight, particularly preferably at least 60% by weight, most preferably at least 70% by weight, most preferably at least 80% by weight, in each case based on the total weight of the organic filler according to the invention. Preferably, the Klason lignin content in the organic filler according to the invention is at least 50% by weight, particularly preferably at least 60% by weight, most preferably at least 70% by weight, most preferably at least 80% by weight. The Klason lignin content is preferably determined as acid-insoluble lignin according to TAPPI T 222.

Preferably, the lignin and preferably the organic filler according to the invention as such, in particular if it is a lignin-based filler, is at least partly present in hydrothermally treated form and is in each case particularly preferably obtainable by means of hydrothermal treatment. Particularly preferably, the organic filler according to the invention is based on lignin obtainable by means of hydrothermal treatment. Suitable methods of hydrothermal treatment, in particular of lignins and lignin-containing organic fillers, are described, for example, in WO 2017/085278 A1 and WO 2017/194346 A1 and in EP 3 470 457 A1. Preferably, the hydrothermal treatment is carried out at temperatures between 150° C. and 250° C. in the presence of liquid water.

Preferably, the organic filler according to the invention has a pH in a range from 7 to 9, more preferably in a range from >7 to <9, most preferably in a range from >7.5 to <8.5.

The organic filler according to the invention preferably has a d99 value of <25.0 μm. The method for determining the d99 value is described below in the methods section and is carried out by laser diffraction according to ISO 13320:2009. The organic filler according to the invention is preferably present in the form of particles. The average particle size of these particles is/are described by the aforementioned d99. Preferably, the organic filler has a d99 value of <20.0 μm, more preferably of <15.0 μm, particularly preferably of <10 μm, most preferably of <9.0 μm, even more preferably of <8.0 μm, even more preferably of <7.0 μm, most preferably of <6.0 μm, preferably determined in each case by laser diffraction according to ISO 13320:2009.

As outlined hereinbefore, aliphatic carbon-sulfur-carbon linkages are present in the chemical structure of the organic filler, i.e., C_{aliphatic}—S—C-linkages. The aliphatic carbon atom (C_{aliphatic}) of such a linkage corresponds to the at least one aliphatic carbon atom present in the chemical structure of the organic filler, to which a hydroxyl group was bonded. The sulfur atom(S) of such a linkage corresponds to a sulfur atom being present in the sulfur atom(s)-containing organic residue and is covalently bonded to the aforementioned aliphatic carbon atom (C_{aliphatic}) within the chemical structure of the organic filler according to the present invention. The covalently bonded sulfur atom(s)-containing organic residue contains at least one sulfur atom, but may contain one or more additionally present sulfur atoms. Hence, the expression “sulfur atom(s)” comprises the presence of precisely one sulfur atom or of more than one sulfur atoms. However, at least one sulfur atom within said organic residue is positioned adjacently to a carbon atom, such that aliphatic carbon-sulfur-carbon linkages in the chemical structure of the organic filler have been formed and are present. Preferably, said at least one sulfur atom is a sulfur atom that originates from a thiol group of an organic modification used. Said at least one sulfur atom is also covalently bonded to the other carbon atom (C) of such a linkage, which corresponds to the carbon atom being positioned adjacently to the sulfur atom within the sulfur atom-containing organic residue. Said other carbon atom is, hence, different from the aforementioned aliphatic carbon atom, although it also may be and preferably is an aliphatic carbon atom as well. The C_{aliphatic}—S—C-linkages present in the chemical structure of the organic filler represent thioether linkages.

Preferably, the (other) carbon atom being positioned adjacently to the aforementioned sulfur atom of the covalently bonded sulfur atom-containing organic residue, is not part of an unsubstituted and/or saturated hexyl group. More preferably, the (other) carbon atom being positioned adjacently to the aforementioned sulfur atom of the covalently bonded sulfur atom-containing organic residue, is—if part of an unsubstituted and/or saturated linear aliphatic group—part of such a group, which has a number of carbon atoms of at least seven.

The polarity of the organic filler is advantageously changed by the at least partial substitution of the hydroxyl groups, which are bonded to at least one aliphatic carbon atom. Depending on the type of modification agent used, a physical shielding effect may additionally occur.

Preferably, the organic filler does not comprise aliphatic carbon-sulfur-carbon linkages in its chemical structure, wherein the latter carbon atom (i.e., not the aliphatic carbon) is part of an unsubstituted and/or saturated hexyl group. More preferably, in case the organic filler comprises aliphatic carbon-sulfur-carbon linkages in its chemical structure, wherein the latter carbon atom (i.e., not the aliphatic carbon) is part of an unsubstituted and/or saturated linear aliphatic group, such a group has a minimum number of carbon atoms of at least seven. A minimum number of seven carbon atoms advantageously provided an improved physical shielding effect due to its comparatively long-chain hydrophobic moiety.

Preferably, the hydroxyl groups, more preferably primary hydroxyl groups, which are bonded to at least one aliphatic carbon (hereinafter also referred to as “aliphatic OH-groups”), are present on the surface of particles of the organic filler (and are, hence, part of chemical structure of the organic filler). Hence, in such a case these groups represent so-called surface-available groups. Consequently, the formed aliphatic carbon-sulfur-carbon linkages (thioether linkages) are preferably also present on the surface of particles of the organic filler.

Preferably, the hydroxyl groups, more preferably primary hydroxyl groups, of the organic filler, which are bonded to the at least one aliphatic carbon atom,—and which have been at least partially substituted with a covalently bonded sulfur atom(s)-containing organic residue as mentioned hereinbefore—are hydroxyl groups being attached to an aliphatic residue comprising the at least one aliphatic carbon atom, more preferably being attached to a C₁₋₃ aliphatic or C₄₋₆ heteroaliphatic residue, even more preferably being attached to a C₃ aliphatic or a Ce heterocycloaliphatic residue, still more preferably being attached to a C₃ aliphatic residue, yet more preferably being attached to a C₃ alkyl residue.

The expression “at least in part” in connection with the term “at least a part of the hydroxyl groups being present in the chemical structure of the organic filler, which are bonded to at least one aliphatic carbon atom, has been substituted with ( . . . )” means “partially” or “completely”, preferably, however, means “partially”. Hence, preferably, not all hydroxyl groups, which are bonded to at least one aliphatic carbon atom in the chemical structure of the organic filler, have been substituted with a covalently bonded sulfur atom(s)-containing organic residue.

Preferably, the sulfur atom(s)-containing organic residue mentioned hereinbefore is a divalent organic residue, within which at least one sulfur atom is positioned adjacently to an aliphatic carbon atom, such that aliphatic carbon-sulfur-aliphatic carbon linkages in the chemical structure of the organic filler have been formed and are present therein. Preferably, the sulfur atom(s)-containing organic residue was part of an organic modification agent comprising at least one thiol group, wherein the aforementioned at least one sulfur atom present in the sulfur atom-containing organic residue originates from the thiol group of the organic modification agent.

The sulfur atom(s)-containing organic residue preferably contains an organic radical selected from aliphatic, cycloaliphatic, heteroaliphatic, heterocycloaliphatic, aromatic, and heteroaromatic radicals, more preferably selected from aliphatic, cycloaliphatic, and heteroaliphatic radicals, even more preferably selected from aliphatic and heteroaliphatic radicals, still more preferably selected from aliphatic radicals, wherein in each case linear unsubstituted radicals with six carbon atoms are preferably excluded, particularly wherein in each case the linear unsubstituted aliphatic radicals mentioned have at least seven carbon atoms.

Each of the aforementioned organic radicals may be unsubstituted, but may alternatively also be substituted, in particular with at least one functional group. For example, the organic radical may contain at least one functional group, which-when the filler according to the invention is used together with at least one rubber within a rubber composition—has a reactivity towards the at least one rubber and/or towards at least one functional group of this rubber and/or towards a vulcanization system present in the rubber composition, in particular during vulcanization, wherein the at least one functional group is preferably selected from the group consisting of preferably non-conjugated and/or conjugated carbon-carbon double bonds, in particular vinyl groups, and sulfur-containing groups as well as mixtures thereof, particularly preferably selected from the group consisting of cis-standing carbon-carbon double bonds, mercapto groups, which may optionally be blocked, and di- and/or polysulfide groups, thioketone groups, mercaptobenzothiazole groups and dithiocarbamate groups, and mixtures thereof. Additionally, or alternatively, the organic radical may contain least one functional group, which increases the basicity of the filler after formation of the aliphatic carbon-sulfur-aliphatic carbon linkages in the chemical structure of the organic filler has occurred, particularly preferably an amino group, especially an amino group selected from the group consisting of primary and secondary amino groups. It is also possible that further chemical bonding to the filler occurs via the at least one further functional group FGB of the organic modifier, in particular if this is an amino group. Additionally, or alternatively, the organic radical may contain least one alkoxylsilyl group, which allows crosslinking or transversal crosslinking within the organic filler via formation of siloxane bonds.

Preferably, hydroxyl groups are still present in the chemical structure of the organic filler, which are bonded to at least one aliphatic carbon atom, i.e., aliphatic OH-groups are still present, in particular since only a part of these hydroxyl groups has been substituted with the covalently bonded sulfur atom-containing organic residue.

Preferably, the organic filler further comprises at least one kind of functional groups selected from aromatic hydroxyl groups, preferably phenolic hydroxyl groups including phenolate groups, and carboxylic acid groups including carboxylate groups.

Preferably, the aliphatic carbon-sulfur-carbon linkages present in the chemical structure of the organic filler have been introduced by a reaction of at least part of the hydroxyl groups being bonded to at least one aliphatic carbon atom with at least one organic modification agent, which comprises at least one thiol group being positioned adjacently to a carbon atom within its chemical structure, more preferably by a substitution reaction, wherein at least part of these hydroxyl groups have been replaced with a covalently bonded sulfur atom-containing organic residue, wherein the sulfur atom present therein originates from the thiol group of the organic modification agent.

The at least one thiol group of the at least one organic modification agent, which comprises at least one thiol group being positioned adjacently to a carbon atom within its chemical structure, can also be generated in situ via a nucleophilic ring opening of a substituted or unsubstituted thiirane, which serves as a thiol-precursor.

Preferably, the sulfur content, based on the total weight of the organic filler, is >1.0 wt.-%, more preferably is in a range of from >1.0 wt.-% to 5.0 wt.-%, even more preferably of from 1.1 to 4.5 wt.-%, still more preferably 1.2 wt.-% to 4.0 wt.-%, even more preferably of from 1.3 wt.-% to 3.5 wt.-%, yet more preferably of from 1.3 to 3.0 wt.-%, in particular of from 1.4 to 2.5 wt.-%. The sulfur content is determined according to the method disclosed in the ‘method’ section.

Preferably, the organic modification agent used is a non-polymeric modification agent, more preferably is monomeric. As it will be outlined hereinafter, however, alternatively it is preferably, that the organic modification agent is a polymeric modification agent.

Preferably, the aliphatic carbon-sulfur-carbon linkages in the chemical structure have been introduced by a reaction of at least part of the hydroxyl groups being bonded to at least one aliphatic carbon atom with at least one organic modification agent,
which is at least one thiol of general formula (I),

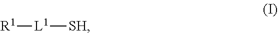

wherein L¹ is selected from C₂₋₃₀ alkylene groups, C₂₋₃₀ heteroalkylene groups, C₃₋₃₀ alkenylene groups, C₂₋₃₀ heteroalkenylene groups, C₃₋₃₀ alkynylene groups and C₂₋₃₀ heteroalkynylene groups, wherein one or more hydrogen atoms of any of these groups are optionally and/or independently of each other replaced by at least one of fluorine, hydroxyl groups and/or O—C₁₋₄ alkyl groups, and R¹ is an OH-group, an O—C₁₋₄ alkyl group, an SH-group, an S—C₁₋₄ alkyl group, a C(═O)OR¹¹ group, an NR¹¹R¹² group, an NR¹¹C(═O)NR¹²R¹³ group, an NR¹¹C(═O)OR¹², an OC(═O)NR¹¹R¹² group, an S(═O)₂NR¹¹ group, an OPO₃²⁻ group or salts thereof, an OC(═O)O group or salts thereof, a C(NR¹¹)R¹² group, an NR¹¹CNR¹²NR¹³R¹⁴ group, a C(═O)SR¹¹ or a C(═S)OR¹¹ group, or a halide, wherein R¹¹, R¹², R¹³ and R¹⁴ are independently selected from H, C₁₋₈ alkyl, C₁₋₈ alkenyl and C₁₋₈ alkynyl,
and/or
which is at least one thiol of general formula (II),

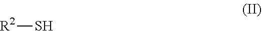

wherein R² is a C₁₋₃₀ hydrocarbon group, which may optionally contain one or more heteroatoms and/or heteroatom groups, wherein the heteroatoms are preferably selected from O, S and N, more preferably selected from O and S, even more preferably selected from O, and wherein the heteroatom groups are preferably selected from NH, and NR with R being a C₁₋₄ aliphatic residue, preferably a C₁₋₃₀ hydrocarbon group excluding a saturated and/or unsaturated Ce-hydrocarbon group, more preferably excluding any Ce-hydrocarbon group, even more preferably a C₇₋₃₀ hydrocarbon group, in each case wherein one or more hydrogen atoms are optionally and/or independently of each other replaced by at least one of fluorine, hydroxyl groups and/or O—C₁₋₄ alkyl groups,
and/or
which is at least one thiol of general formula (III),

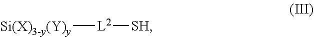

wherein y is an integer from 0 to 3, preferably from 0 to 2, more preferably 0,
wherein Y is a non-hydrolyzable organic residue, preferably a C₁₋₃₀ alkyl group, which preferably is unsubstituted, or represents a residue L²-SH, wherein L² has the meaning defined hereinafter,
wherein X is in each case independently of one another represents a hydrolyzable group, which preferably is reactive with at least one of phenolic OH-groups, phenolate groups, aliphatic OH-groups, carboxylic acid groups, carboxylate groups, silyl ether groups and mixtures thereof, preferably represents a hydrolyzable group selected from O—C₁₋₄ alkyl groups, O(CH₂)ₐ—O(CH₂)_{b}—CH₃ groups, wherein a is an integer from 2 to 3 and b is an integer from 1 to 14, halides, and mixtures thereof, and
wherein L² is a divalent non-hydrolyzable organic residue, preferably selected from C₁₋₃₀ alkylene groups, more preferably selected from C₁₋₁₆ alkylene group, even more preferably selected from C₁₋₆ alkylene groups, most preferably from C₁₋₃ alkylenes groups, wherein in each case one or more hydrogen atoms are optionally and/or independently of each other replaced by at least one of fluorine and O—C₁₋₄ alkyl-groups, preferably, however wherein each of the aforementioned alkylene groups is unsubstituted,
and/or
which is at least one thiirane of general formula (IV) as thiol-precursor,

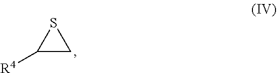

wherein R⁴ is a C₁₋₃₀ hydrocarbon group, which may optionally contain one or more heteroatoms and/or heteroatom groups, wherein the heteroatoms are preferably selected from O, S and N, more preferably selected from O and S, even more preferably selected from O, and wherein the heteroatom groups are preferably selected from NH, and NR with R being a C₁₋₄ aliphatic residue, preferably a C₇₋₃₀ hydrocarbon group, in each case wherein one or more hydrogen atoms are optionally and/or independently of each other replaced by at least one of fluorine, hydroxyl groups and/or O—C₁₋₄ alkyl groups,
and/or
which is at least one polymeric polythiol having at least two or more preferably terminal thiol-groups, preferably at least one polysulfide having two, three or more preferably terminal thiol groups.
C₂₋₃₀ heteroalkylene groups, C₂₋₃₀ heteroalkenylene groups, and C₂₋₃₀ heteroalkynylene groups as mentioned hereinbefore, e.g., in connection with the definition of L¹, are alkylene groups, alkenylene groups, and alkynylene groups, which additionally contain one or more heteroatoms and/or heteroatom groups, wherein the heteroatoms are preferably selected from O, S and N, more preferably selected from O and S, even more preferably selected from O, and wherein the heteroatom groups are preferably selected from NH, and NR with R being a C₁₋₄ aliphatic residue. The heteroatom(s) and/or heteroatom group(s) can be present within the respective group, i.e., can be positioned between for example two carbon atoms such as in case of a C₂H₄—O—C₂H₄-group, but can alternatively or additionally also represent a terminus of the respective group, such as in case of a O—C₂H₄—O—C₂H₄-group or in case of a O—C₂H₄-group.

In case L¹ represents a C₂₋₃₀ heteroalkylene group, said group is preferably selected from [(CH₂)_{c}O]_{d}(CH₂)ₑ or [(CH₂)_{c}S]_{d}(CH₂)ₑ, wherein c is an integer from 2 to 3, preferably 2, d is an integer from 1 to 6, preferably from 2 to 4, more preferably d is 2, and wherein e is an integer from 2 to 4, preferably 2 to 3, more preferably e is 2.

The C₁₋₃₀ hydrocarbon group, which may optionally contain one or more heteroatoms and/or heteroatom groups in position R² of formula (II) may, e.g., be a C₂₋₃₀ heteroalkylene group such as [(CH₂)_{c}O]_{d}(CH₂)ₑ or [(CH₂)_{c}S]_{d}(CH₂)ₑ, wherein c is an integer from 2 to 3, preferably 2, d is an integer from 1 to 6, preferably from 2 to 4, more preferably d is 2, and wherein e is an integer from 2 to 4, preferably 2 to 3, more preferably e is 2.

Examples of thiols of general formula (III) are mercaptoalkyl trialkoxysilanes such as mercaptomethyl trimethoxysilane and/or mercaptopropyl trimethoxysilane. An example of a thiol of general formula (I) is 1,2-bis(2-mercaptoethoxy) ethane.

As mentioned hereinbefore the aliphatic carbon-sulfur-carbon linkages in the chemical structure may have been alternatively and/or additionally introduced by a reaction of at least part of the hydroxyl groups being bonded to at least one aliphatic carbon atom with at least one organic modification agent, which is at least one polymeric polythiol having at least two or more preferably terminal thiol-groups, for example a polymeric polythiol such as a polysulfide having two, three or more preferably terminal thiol groups. Preferably, the polymeric polythiols suitable for this purpose have a weight average molecular weight (M_{w}), determinable by gel permeation chromatograph (GPC), in a range of from 500 to 50,000 g/mol, more preferably of from 500 to 25,000 g/mol, even more preferably of from 750 to 10,000 g/mol or 5,000 g/mol.

In the scheme displayed hereinafter a possible reaction sequence for introduction of the aliphatic carbon-sulfur-carbon linkages present in the chemical structure of the organic filler is exemplarily shown, when a thiol of general formula (III) as mentioned above is used. HTT therein means a lignin obtainable by hydrothermal treatment having aliphatic OH-groups.

### Scheme: Possible Reaction Sequence:

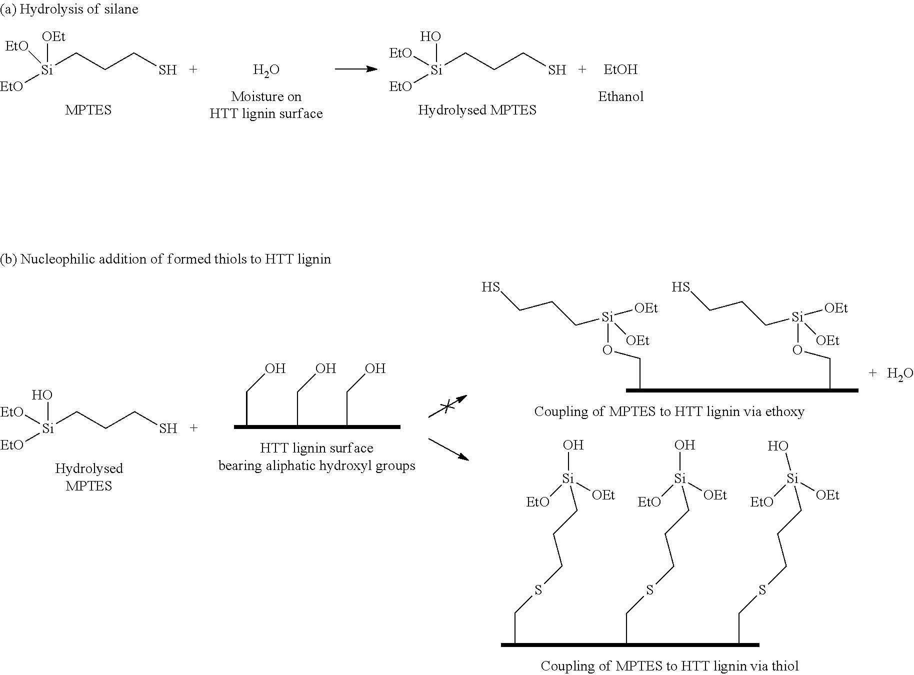

For the production of the organic filler according to the invention, an organic filler precursor FPM with a ¹⁴C-content in the range of 0.20 to 0.45 Bq/g carbon and a BET surface area in a range of 10 to <200 m²/g is suitable as starting material, which contains at least one hydroxyl group bonded to at least one aliphatic carbon atom. The formation of any aliphatic carbon-sulfur-carbon linkages has not yet occurred at this time. At least in this manner the filler precursor FPM differs from the organic filler according to the invention.

Preferably, the organic filler is obtainable by carrying out at least one step a) and optionally one or more of steps b) to d), namely
a) bringing together at least one organic modification agent, which comprises at least one thiol group being positioned adjacently to a carbon atom within its chemical structure, and at least one organic filler precursor FPM having a ¹⁴C content in a range of from 0.20 to 0.45 Bq/g carbon, having a BET surface area in a range of 10 to <200 m²/g, and having at least one hydroxyl group bonded to at least one aliphatic carbon atom,
b) optionally heating the mixture obtained according to step a), which is preferably present within a liquid or gaseous reaction medium or alternatively represents a solid phase, preferably to a temperature in a range from 30° C. to 190° C., more preferably to a temperature in a range from 50° C. to 180° C., most preferably to a temperature in a range from 70° C. to 170° C.,
c) optionally extracting at least one organic solvent, in case of step a) and/or the optional heating according to step b) have been carried out in a liquid reaction medium containing at least one organic solvent, after at least a part of the hydroxyl groups, which are bonded to at least one aliphatic carbon atom of the organic filler precursor FPM, has been substituted with a covalently bonded sulfur atom(s)-containing organic residue, wherein at least one sulfur atom present therein originates from the thiol group of the organic modification agent, and
d) optional drying of the organic filler obtained after carrying out step a) and optionally step b) and/or c), preferably under vacuum and/or at a temperature in a range from 20 to 100° C.

The bringing together according to step a) and optionally also the heating according to optional step b) can be carried out in a reaction medium, which is preferably liquid or gaseous. The organic modification agent used and/or the filler precursor FPM and/or the resulting mixture can in each case optionally be present in a liquid or gaseous reaction medium. The liquid reaction medium may thereby preferably contain or consist of at least one organic solvent, particularly preferably at least one hydrocarbon, most preferably at least one aliphatic and/or aromatic hydrocarbon. In the case of a gaseous reaction medium, the covalent bonding of the organic modification agent to the filler precursor FPM can be achieved by CVD (chemical vapor deposition) and/or plasma modification.

Preferably, step a) is carried out at room temperature (18 to <30° C.). The covalent bonding of the organic modification agent to the filler precursor FPM can already take place under these conditions. Optionally and preferably, however, step b) is carried out. In this case, the covalent bonding of the organic modification agent to the filler precursor FPM preferably takes place at the temperature ranges mentioned above in connection with step b).

The extraction according to optional step c) is preferably carried out at a temperature in a range of 20 to 150° C. and may optionally be carried out under vacuum.

Preferably, after and/or during the performance of step a) and optional step b), the reaction mixture is mixed for a period of from 0.01 to 30 h, particularly preferably from 0.01 to 5 h, for example by stirring, in particular to achieve complete reaction with the organic modification agent used in the amount used.

Preferably, the organic filler according to the invention is present in rubber-free form and/or has been produced in rubber-free form. This means in particular that the formation of the aliphatic carbon-sulfur-carbon linkages, which are present in the chemical structure of the organic filler, does not take place in situ within a rubber composition or in presence of a rubber, but already takes place in a separate step (“ex situ”).

Preferably, after aliphatic carbon-sulfur-carbon linkages have been formed, the organic filler according to the invention contains, based on its total weight, the organic modification agent in a proportion in the range from 0.1 to 30% by weight, particularly preferably from 0.5 to 25% by weight, most preferably from 1 to 15% by weight, especially from 1.5 to 12% by weight. It is, of course, be taken into account here that, during the substitution reaction involving the thiol groups of the organic modification agent and the aliphatic hydroxyl groups of the organic filler precursor FPM, cleavage products such as water may be formed, which thus do not contribute to the proportion of modifier in the filler.

### Rubber Composition

A further subject-matter of the present invention is a rubber composition comprising at least one rubber and at least one filler component,
wherein the filler component comprises at least one organic filler as defined hereinbefore and hereinafter,
and/or
wherein the filler component comprises (i) at least one organic filler precursor FPM having a ¹⁴C content in a range of from 0.20 to 0.45 Bq/g carbon, having a BET surface area in a range of 10 to <200 m²/g, and having at least one hydroxyl group bonded to at least one aliphatic carbon atom, and (ii) at least one organic modification agent, which comprises at least one thiol group being positioned adjacently to a carbon atom within its chemical structure, by means of which a covalent bond to the at least one organic filler precursor FPM can be formed through at least partial substitution of the hydroxyl groups being present in the chemical structure of the organic filler precursor FPM, which are bonded to at least one aliphatic carbon atom, with a covalently bonded sulfur atom(s)-containing organic residue such that aliphatic carbon-sulfur-carbon linkages in the chemical structure of the organic filler are generated, wherein at least one sulfur atom present therein originates from the thiol group of the organic modification agent (ii), and an organic filler as defined hereinbefore and hereinafter is formed.

All preferred embodiments described hereinbefore in connection with the organic filler according to the invention are also preferred embodiments with respect to the rubber composition according to the invention.

Preferably, the filler component comprises at least one organic filler according to the invention as described in connection with the first subject matter of the present invention.

Any type of rubber is suitable for the production of the rubber compounds according to the invention. Natural rubber (NR) and synthetic rubbers are known to the skilled person. Preferably, the least one rubber is selected from the group consisting of natural rubber (NR), halobutyl rubbers, again preferably selected from the group consisting of chlorobutyl rubbers (CIIR; chloro-isobutene-isoprene rubber) and bromobutyl rubbers (BIIR; bromo-isobutene-isoprene rubber), and mixtures thereof, butyl rubber or isobutylene-isoprene rubber, respectively, isobutylene-isoprene rubber (IIR; isobutene-isoprene rubber), styrene-butadiene rubber (SBR, styrene butadiene rubber), again preferably SSBR and/or ESBR, polybutadiene (BR, butadiene rubber), acrylonitrile-butadiene rubbers (NBR, nitrile rubber) and/or HNBR (hydrogenated NBR), chloroprene (CR), polyisoprene (IR), ethylene-propylene-diene rubber (EPDM), and mixtures thereof.

Particularly preferred is the at least one rubber selected from the group consisting of styrene-butadiene rubber (SBR, styrene butadiene rubber), again preferably SSBR, polybutadiene (BR, butadiene rubber), EPDM, NR and acrylonitrile-butadiene rubbers (NBR, nitrile rubber) as well as mixtures thereof. Particularly preferred are styrene-butadiene rubber (SBR, styrene butadiene rubber), again preferably SSBR and polybutadiene (BR, butadiene rubber) as well as mixtures thereof.

In the case of blends of SBR and BR, the proportion of SBR is preferably higher than the proportion of BR. The total amount of SBR rubber is preferably 60 to 100 phr, preferably 65 to 100 phr, particularly preferably 70 to 100 phr. The total amount of BR rubber is preferably 0 to 40 phr, preferably 0 to 35 phr, particularly preferably 0 to 30 phr.

The phr (parts per hundred parts of rubber by weight) specification used herein is the quantity specification commonly used in the rubber industry for compound formulations. The dosage of the parts by weight of the individual components is always related to 100 parts by weight of the total mass of all rubbers present in the compound.

Preferably, the rubber composition comprises the at least one organic filler in an amount ranging from 10 to 150 phr, particularly preferably 15 to 130 phr, most preferably 20 to 120 phr, especially from 40 to 100 phr, and/or comprises the at least one organic filler precursor FPM as defined under (i) hereinbefore in an amount which is in a range from 10 to 150 phr, particularly preferably 15 to 130 phr, most preferably to 120 phr, especially from 40 to 100 phr, and the at least one organic modification agent as defined under (ii) hereinbefore in an amount which is in a range from 0.1 to 30 wt. %, particularly preferably from 0.5 to 25 wt. %, most preferably from 1.0 to 15 wt. %, in particular from 1.5 to 12 wt. %, in each case based on the total weight of the organic filler precursor FPM. As explained above, any elimination products formed do not contribute to the amount of the organic modification agent, based on the total weight of filler FPM.

In addition to the organic filler according to the invention and/or organic filler precursor FPM, the rubber compositions may contain other fillers different from these fillers.

In the case that the organic filler according to the invention serves only as a partial replacement of common industrial carbon blacks, the rubber compositions according to the invention may also contain industrial carbon blacks, in particular furnace carbon blacks such as those classified as general purpose or industrial carbon blacks under ASTM code N660.

Additionally, or alternatively, the rubber compositions according to the invention may in particular contain inorganic fillers, for example of different particle size, particle surface area and chemical nature with different potential to influence the vulcanization behavior. In the event that further fillers are included, these should preferably have properties as similar as possible to those of the organic fillers of the invention used in the rubber composition according to the invention, in particular with regard to their pH.

If further fillers are used, these are preferably phyllosilicates such as clay minerals, for example talc; carbonates such as calcium carbonate; silicates such as calcium, magnesium and aluminum silicate; and oxides such as magnesium oxide and silica or silicic acid.

In particular, in the case where the organic filler according to the invention serves only as a partial substitute for conventional silicas or silica, the rubber compositions according to the invention may also contain such inorganic fillers as silica or silicic acid.

In the context of the present invention, however, zinc oxide does not count as an inorganic filler, since the function of zinc oxide is that of a vulcanizer or vulcanization-promoting additive. Additional fillers should, however, be chosen with care, since higher amounts of magnesium oxide, for example, can have a negative effect on adhesion to adjacent tire layers, and silica tends to bind organic molecules such as the thiazoles used in some vulcanization systems to its surface and thus inhibit their action.

Inorganic fillers, including preferably silica and other fillers carrying Si—OH groups on their surface, can also be surface treated (surface modified). In particular, silanization with organosilanes such as alkylalkoxysilanes or aminoalkylalkoxysilanes or mercaptoalkylalkoxysilanes can be advantageous. For example, the alkoxysilane groups can bind to the surfaces of silicates or silica by hydrolytic condensation, or to other suitable groups, while, for example, the amino groups and thiol groups can react with isoprene units of certain rubbers. This can provide mechanical reinforcement of the vulcanized rubber compositions of the present invention.

The fillers other than the organic fillers according to the invention can be used individually or in combination with each other.

In case further fillers are used, their proportion is preferably less than 40 phr, more preferably 20 to 40 phr and especially preferably 25 to 35 phr.

The rubber composition according to the invention may contain further optional ingredients such as plasticizers and/or antidegradants, resins, in particular adhesion-enhancing resins, and even already vulcanizers and/or vulcanization-promoting additives such as zinc oxide and/or fatty acids such as stearic acid.

The use of plasticizers can influence in particular properties of the non-vulcanized rubber composition, such as processability, but also properties of the vulcanized rubber composition, such as its flexibility, especially at low temperatures. Particularly suitable plasticizers in the context of the present invention are mineral oils from the group of paraffinic oils (essentially saturated chain-shaped, hydrocarbons) and naphthenic oils (essentially saturated ring-shaped hydrocarbons). The use of aromatic hydrocarbon oils is also possible and even preferred. However, a mixture of paraffinic and/or naphthenic oils with aromatic oils may also be advantageous as plasticizers in terms of adhesion of the rubber composition to other rubber-containing components in tires, such as the carcass. Other possible plasticizers include esters of aliphatic dicarboxylic acids, such as adipic acid or sebacic acid, kerosene waxes and polyethylene waxes. Among the plasticizers, paraffinic oils and naphthenic oils are particularly suitable in the context of the present invention, but most preferred are aromatic oils, especially aromatic mineral oils.

Preferably, plasticizers and very preferably hereunder the paraffinic and/or naphthenic and in particular aromatic process oils are used in an amount of 0 to 100 phr, preferably to 70 phr, more preferably 20 to 60 phr, in particular from 20 to 50 phr.

Examples of antidegradants include quinolines such as TMQ (2,2,4-trimethyl-1,2-dihydroquinoline) and diamines such as 6-PPD (N-(1,3-dimethylbutyl)-N′-phenyl-p-phenylenediamine).

To improve the adhesion of the vulcanized rubber compound of the present invention to other adjacent tire components, so-called adhesion-enhancing resins can be used. Particularly suitable resins are those based on phenol preferably from the group consisting of phenolic resins, phenol-formaldehyde resins and phenol-acetylene resins. In addition to phenolic-based resins, aliphatic hydrocarbon resins such as Escorez™ 1102 RM from ExxonMobil, as well as aromatic hydrocarbon resins, can also be used. Aliphatic hydrocarbon resins particularly improve adhesion to other rubber components of the tire. They generally have lower adhesion than the phenolic-based resins and can be used alone or mixed with the phenolic-based resins.

If adhesion-enhancing resins are used, then preferably those selected from the group consisting of phenol-based resins, aromatic hydrocarbon resins and aliphatic hydrocarbon resins. Preferably, their content is 0 to 15 phr or 1 to 15 phr, more preferably 2 to 10 phr and most preferably 3 to 8 phr.

The rubber composition according to the invention may also contain additives which promote vulcanization but are not capable of triggering it independently. Such additives include, for example, vulcanization accelerators such as saturated fatty acids with 12 to 24, preferably 14 to 20 and particularly preferably 16 to 18 carbon atoms, such as stearic acid and the zinc salts of the aforementioned fatty acids. Thiazoles can also be among these additives. However, it is also possible to use vulcanization-promoting additives only in the vulcanization systems described below.

If vulcanization-promoting additives and in particular the above-mentioned fatty acids and/or their zinc salts, preferably stearic acid and/or zinc stearate, are used in the rubber compositions according to the invention, their proportion is 0 to 10 phr, particularly preferably 1 to 8 phr and especially preferably 2 to 6 phr.

Moreover, the rubber composition according to the invention may already contain certain vulcanizers such as zinc oxide, which is preferred. However, it is also possible to use such vulcanizers only in the vulcanization systems described below.

If vulcanizers such as zinc oxide are used in the rubber compositions according to the invention, their proportion is preferably 0 to 10 phr, more preferably 1 to 8 phr and especially preferably 2 to 6 phr.

### Vulcanizable Rubber Composition

A further subject-matter of the present invention is a vulcanizable rubber composition comprising the rubber composition as defined hereinbefore and hereinafter and a vulcanization system, preferably comprising at least zinc oxide and/or at least sulfur or a sulfur donor and/or at least one peroxide, particularly preferably comprising at least sulfur.

All preferred embodiments described hereinbefore in connection with the organic filler and the rubber composition according to the invention are also preferred embodiments with respect to the vulcanizable rubber composition according to the invention.

The term “vulcanizing” in the sense of the present invention means “crosslinking” and the term “vulcanization system” in the sense of the present invention means “crosslinking system”. In the same manner “vulcanizable” means “crosslinkable” and “vulcanized” means “crosslinked”. These definitions are known by a person skilled in the art, e.g., from PAC 2007, 79, 1801 on page 1826, and from “Kautschuk Technologie” by F. Rothemeyer and F. Sommer, 3^{rd} edition, 2013. In particular, not only, e.g., sulfur-vulcanization, is included in the term “vulcanizing”, but also other kinds of crosslinking reactions, e.g., with peroxides.

The vulcanization systems are not counted herein as part of the rubber compositions according to the invention but are treated as additional systems conditioning the crosslinking. By adding the vulcanization systems to the rubber compositions according to the invention, the vulcanizable rubber compositions also according to the invention are obtained.

The rubber component of the vulcanizable rubber composition according to the invention, which contains at least one rubber, allows the use of a wide variety of different vulcanization systems.

The vulcanization of the rubber compositions of the present invention is preferably carried out using at least zinc oxide and/or at least sulfur and/or at least one peroxide such as, in particular, at least one organic peroxide. If zinc oxide is used, it may be added to the rubber component (A) or to the component (B). Preferably, zinc oxide is added to component (A). If sulfur is used, it is preferably added to component (B).

Preferably, at least zinc oxide and/or at least sulfur is used in combination with different organic compounds for vulcanization. The different additives can influence the vulcanization behavior as well as the properties of the vulcanized rubbers obtained.

In a first variant of a vulcanization based at least on zinc oxide, small amounts of a saturated fatty acid with 12 to 24, preferably 14 to 20 and particularly preferably 16 to 18 carbon atoms, for example stearic acid and/or zinc stearate, are preferably added to the zinc oxide as a vulcanization accelerator. This allows the vulcanization rate to be increased. However, the final extent of vulcanization is usually reduced when the fatty acids mentioned are used.

In a second variant of a vulcanization based at least on zinc oxide, so-called thiurams such as thiurammonosulfide and/or thiuramdisulfide and/or tetrabenzylthiuramdisulfide (TBzTD) and/or dithiocarbamates and/or sulfenamides are added to the zinc oxide, in the absence of sulfur or alternatively in the presence of sulfur, in order to shorten the scorch time and improve the vulcanization efficiency with the formation of particularly stable networks. The thiazoles and sulfenamides are preferably selected from the group consisting of 2-mercaptobenzothiazole (MBT), mercaptobenzothiazyl disulfide (MBTS), N-cyclohexyl-2-benzothiazyl sulfenamide (CBS), 2-morpholinothiobenzothiazole (MBS) and N-tert-butyl-2-benzothiazyl sulfenamide (TBBS).

In a third variant of a vulcanization based on at least zinc oxide, an alkylphenol disulfide is added to the zinc oxide in order to adapt the scorch times, in particular to accelerate them. A further, fourth variant of a vulcanization based at least on zinc oxide uses a combination of zinc oxide with polymethylolphenol resins and halogenated derivatives thereof, in which preferably neither sulfur nor sulfur-containing compounds are used.

In a further fifth variant of at least zinc oxide-based vulcanization, which is most preferred, the vulcanization is carried out by means of a combination of zinc oxide with thiazoles and/or thiurams and/or sulfenamides, and preferably sulfur. The addition of sulfur to such systems increases both the rate and extent of vulcanization and contributes to the processability of the rubber compositions during the vulcanization process. The use of this vulcanization system preferably provides heat- and fatigue-resistant vulcanizates that exhibit good adhesion to other components of vehicle tires, particularly rubber compositions of the carcass, even when vulcanized. A particularly advantageous vulcanization system comprises zinc oxide, a thiuram such as tetrabenzylthiuram disulfide (TBzTD), a sulfenamide such as N-tert-butyl-2-benzothiazylsulfenamide (TBBS), and sulfur. Particularly preferred is the combination of the first variant with the fifth variant, i.e. the use of a vulcanization system comprising zinc oxide, a thiuram such as tetrabenzylthiuram disulfide (TBzTD), a sulfenamide such as N-tert-butyl-2-benzothiazylsulfenamide (TBBS), sulfur and stearic acid and/or optionally zinc stearate.

Less preferred vulcanization systems are based on pure sulfur vulcanization or peroxide vulcanization, the latter of which can lead to an undesirable reduction in molecular weights due to cleavage of the molecules, especially when butyl rubber or other rubbers are used.

In the context of the present invention, the vulcanization of the rubber composition according to the invention is carried out in the presence of the organic fillers according to the invention, such as lignins obtained via hydrothermal treatment.

Components of the vulcanization systems, which as such cannot trigger vulcanization, can also be included in the rubber composition of the present invention as “further components of the rubber composition”, i.e., they can already be part of the rubber composition according to the invention and therefore do not necessarily have to be included in the vulcanization system. Thus, as already mentioned above, it is possible that in particular the stearic acid and/or optionally zinc stearate are already present in the rubber composition according to the invention and the complete vulcanization system is formed in situ, for example, by mixing/adding at least zinc oxide and at least sulfur.

### Kit-of-Parts

Due to the connection between the rubber compositions according to the invention and the crosslinking systems (vulcanization systems) to be selected for their vulcanization for the production of a vulcanizable rubber composition according to the invention, the present invention also relates to a kit-of-parts comprising, in spatially separated form, a rubber composition as part (A) as defined hereinbefore and hereinafter and a vulcanization system as part (B) as defined hereinbefore and hereinafter, preferably a vulcanization system comprising at least zinc oxide and/or at least sulfur.

In the kit-of-parts, the rubber composition according to the invention and the vulcanization system are spatially separated from each other and can thus be stored. The kit-of-parts is used to prepare a vulcanizable rubber composition. For example, the rubber composition according to the invention, which constitutes one part of the kit-of-parts, can be used as part (A) in stage 1 of the process described below for producing a vulcanizable rubber compound, and the second part of the kit-of-parts, namely the vulcanization system, can be used as part (B) in stage 2 of said process.

In contrast to the vulcanizable rubber composition, which already contains both the constituents of the rubber composition according to the invention and of the associated vulcanization system homogeneously mixed, so that the vulcanizable rubber composition can be vulcanized directly, in the kit-of-parts according to the invention the rubber composition according to the invention and the vulcanization system are spatially separated from each other.

All systems already described above in connection with the vulcanizable rubber composition according to the invention can be used as vulcanization system.

All of the preferred embodiments described previously herein in connection with the organic filler of the invention and the (vulcanizable) rubber composition of the invention are also preferred embodiments with respect to the kit-of-parts of the invention.

Preferably, the kit-of-parts according to the invention comprises as
Part (A) a rubber composition according to the invention and as
Part (B) a vulcanization system comprising at least zinc oxide and/or at least sulfur, wherein at least zinc oxide can alternatively be present within part (A).

Particularly preferably, the kit-of-parts according to the invention comprises as
Part (A) a rubber composition according to the invention and as
Part (B) a vulcanization system comprising zinc oxide, sulfur and at least one thiuram, wherein at least zinc oxide may alternatively be present within Part (A).

Even more preferably, the kit-of-parts according to the invention comprises as
Part (A) a rubber composition according to the invention and as
Part (B) a vulcanization system comprising zinc oxide, sulfur, at least one thiuram, and at least one saturated fatty acid such as stearic acid and/or optionally zinc stearate, wherein at least zinc oxide and/or stearic acid and/or zinc stearate may alternatively be present within part (A).

In particular, the kit-of-parts according to the invention comprises as
Part (A) a rubber composition according to the invention and as
Part (B) a vulcanization system comprising zinc oxide, sulfur, at least one thiuram, at least one sulfenamide and at least one saturated fatty acid such as stearic acid and/or optionally zinc stearate, wherein at least zinc oxide and/or stearic acid and/or zinc stearate may alternatively be present within part (A).

The vulcanizable rubber composition according to the invention is preferably prepared in two stages in stages 1 and 2, the rubber composition according to the invention preferably being obtainable after passing through the first stage of this two-stage process.

In the first stage (stage 1), the rubber composition according to the invention is first prepared as a basic mixture (masterbatch) by mixing together all the constituents used to prepare the rubber composition according to the invention. In the second stage (stage 2), the components of the vulcanization system are added to the rubber composition according to the invention.

### Level 1

Preferably, the at least one rubber contained in the rubber component of the rubber composition according to the invention is provided, as well as optionally usable resins different therefrom, preferably improving the adhesion. However, the latter may also be added with the further additives. Preferably, the rubbers are at least at room temperature (23° C.) or are preferably preheated to temperatures of at most 50° C., preferably at most 45° C. and particularly preferably at most 40° C. Particularly preferably, the rubbers are pre-kneaded for a short period before the other ingredients are added. If inhibitors are used for subsequent vulcanization control, such as magnesium oxide, these are preferably also added at this time.

Subsequently, at least one organic filler according to the invention and optionally further fillers are added, preferably with the exception of zinc oxide, since this is used in the rubber compositions according to the invention as a component of the vulcanization system and is therefore not considered herein as a filler. The addition of the at least one organic filler according to the invention and optionally other fillers is preferably incremental.

Advantageously, but not necessarily, plasticizers and other constituents such as stearic acid and/or zinc stearate and/or zinc oxide are added only after the addition of the at least one organic filler according to the invention or the other fillers, if used. This facilitates the incorporation of the at least one organic filler according to the invention and, if present, of the other fillers. However, it may be advantageous to incorporate part of the at least one organic filler according to the invention or, if present, of the further fillers, together with the plasticizers and any further constituents used.

The highest temperatures (“dump temperature”) obtained during the production of the rubber composition in the first stage should not exceed 170° C., since above these temperatures partial decomposition of the reactive rubbers and/or the organic fillers of the invention is possible. However, temperatures of >170° C., for example up to <200° C., are also possible, in particular depending on the rubber used. Preferably, the maximum temperature during the production of the rubber composition of the first stage is between 80° C. and <200° C., particularly preferably between 90° C. and 190° C., most preferably between 95° C. and 170° C.

The mixing of the components of the rubber composition according to the invention is usually carried out by means of internal mixers equipped with tangential or meshing (i.e. intermeshing) rotors. The latter usually allow better temperature control. Mixers with tangent rotors are also called tangential mixers. However, mixing can also be carried out using a double-roller mixer, for example.

After the rubber composition has been prepared, it is preferably cooled before the second stage is carried out. Such a process is also referred to as aging. Typical aging periods are 6 to 24 hours, preferably 12 to 24 hours.

### Stage 2

In the second stage, the components of the vulcanization system are incorporated into the rubber composition of the first stage, thereby obtaining a vulcanizable rubber composition according to the present invention.

If a vulcanization system based on at least zinc oxide and at least sulfur is used as the vulcanization system, at least the sulfur and the other optional constituents, such as in particular at least one thiuram and/or at least one sulfenamide, are preferably added in stage 2. It is also possible to add zinc oxide in stage 2 and, in addition, optionally at least one saturated fatty acid such as stearic acid. However, it is preferable to integrate these constituents into the rubber composition according to the invention already in stage 1.

The highest temperatures (“dump temperature”) obtained during the preparation of the admixture of the vulcanization system to the rubber composition in the second stage should preferably not exceed 130° C., particularly preferably 125° C. A preferred temperature range is between 70° C. and 125° C., particularly preferably 80° C. and 120° C. At temperatures above the maximum temperature of 105 to 120° C. for the crosslinking system, premature vulcanization may occur.

After the vulcanization system has been added in stage 2, the composition is preferably cooled.

In the aforementioned two-stage experience, a rubber composition according to the invention is thus first obtained in the first stage, which is supplemented in the second stage to form a vulcanizable rubber composition.

### Vulcanized Rubber Composition

A further subject-matter of the present invention is a vulcanized rubber composition which is obtainable by vulcanizing the vulcanizable rubber composition as defined hereinbefore and hereinafter or by vulcanizing a vulcanizable rubber composition obtainable by combining and mixing the two parts (A) and (B) of the kit-of-parts as defined hereinbefore and hereinafter.

Prior to vulcanization, the vulcanizable rubber compositions produced preferably undergo shaping processes tailored to the end articles. Rubber compositions are preferably formed by extrusion or calendering into a suitable shape required for the vulcanization process. Vulcanization can take place in vulcanization molds by means of pressure and temperature, or vulcanization can take place without pressure in temperature-controlled channels in which air or liquid materials provide the heat transfer.

All preferred embodiments described hereinbefore in connection with the organic filler according to the invention, the (vulcanizable) rubber composition according to the invention, and the kit-of-parts according to the invention, are also preferred embodiments with respect to the vulcanized rubber composition according to the invention.

Vulcanization is usually carried out under pressure and/or heat. Suitable vulcanization temperatures are preferably from 140° C. to 200° C., particularly preferably 150° C. to 180° C. Optionally, vulcanization is carried out at a pressure in the range from 50 to 175 bar. However, it is also possible to carry out the vulcanization at a pressure range of 0.1 to 1 bar, for example in the case of profiles.

The vulcanized rubber compositions obtained from the vulcanizable rubber compositions according to the invention preferably have a Shore A hardness in the range from more than 50 to less than 70, more preferably from 53 to 65 and most preferably from 55 to 62 and/or a rebound elasticity at 70° C. in the range from more than 60% to less than 75%, more preferably from more than 61% to less than 73%, most preferably from more than 62% to less than 72%. The methods for determining the Shore A hardness and the rebound resilience are given below within the method description.

### Use

A further subject-matter of the present invention is a use of the organic filler as defined hereinbefore and hereinafter for the production of rubber compositions and vulcanizable rubber compositions and of the rubber composition as defined hereinbefore and hereinafter for the production of tires, preferably pneumatic tires and solid tires, in particular pneumatic tires, preferably in each case for their tread, sidewall and/or inner liner, and/or for the production of technical rubber articles, preferably profiles, seals, dampers and/or hoses.

All preferred embodiments described hereinbefore in connection with the organic filler according to the invention, the (vulcanizable) rubber composition according to the invention, the kit-of-parts according to the invention, and the vulcanized rubber composition according to the invention are also preferred embodiments with respect to the aforementioned use according to the invention.

For example, for producing a pneumatic tire, preferably comprising a tread made of the vulcanizable rubber composition according to the invention can be used. The treads are typically vulcanized together with the tire carcass and/or the other tire components under pressure and/or heat. Suitable vulcanization temperatures are preferably from 140° C. to 200° C., particularly preferably 150° C. to 180° C. The process can be carried out, for example, in such a way that the tire blank is molded into the closing mold by closing the press. For this purpose, a small pressure (<0.2 bar) can be applied to an inner bellows (heating bellows) so that the bellows also fits into the tire blank. Then the press and thus also the mold are completely closed. The pressure in the bellows is increased (crowning pressure, usually approx. 1.8 bar). This imprints the profile into the treads as well as the sidewall labeling. In the next step, the press is locked and the clamping force is applied. The clamping force varies depending on the press type and tire size and can be up to 2500 kN using hydraulic cylinders. After the clamping forces have been applied, the actual vulcanization process starts. The mold is continuously heated with steam from the outside. Temperatures of between 15° and 180° C. are generally set here. For the internal medium, there are very different design variants depending on the tire type. For example, steam or hot water is used inside the bladder. The internal pressures can vary and differ according to tire types such as car or truck tires.

### Methods

### 1. Determination of the BET and STSA Surface Area of the Organic Fillers

The specific surface area of the filler under investigation was determined by nitrogen adsorption in accordance with the ASTM D 6556 (2019-01-01) standard intended for industrial carbon blacks. According to this standard, the BET surface area (specific total surface area according to Brunauer, Emmett and Teller) and the external surface area (STSA surface area; Statistical Thickness Surface Area) were also determined as follows.

The sample to be analyzed was dried to a dry substance content ≥97.5 wt. % at 105° C. before measurement. In addition, the measuring cell was dried in a drying oven at 105° C. for several hours before weighing in the sample. The sample was then loaded into the measuring cell using a funnel. If the upper measuring cell shaft became contaminated during filling, it was cleaned using a suitable brush or pipe cleaner. In the case of strongly flying (electrostatic) material, glass wool was weighed in addition to the sample. The glass wool served to retain any flying material that could contaminate the instrument during the heating process.

The sample to be analyzed was baked at 150° C. for 2 hours, the Al₂ O₃ standard at 350° C. for 1 hour. The following N2 dosage was used for the determination depending on the pressure range:
p/p0=0-0.01: N2-dosage: 5 ml/g
p/p0=0.01-0.5: N2-dosage: 4 ml/g.

To determine the BET, extrapolation was performed in the range of p/p0=0.05-0.3 with at least 6 measuring points. To determine the STSA, extrapolation was performed in the range of the layer thickness of the adsorbed N₂ of t=0.4-0.63 nm (corresponds to p/p0=0.2-0.5) with at least 7 measuring points.

### 2. Determination of the Ash Content of the Organic Fillers (TGA; Thermogravimetric Analysis)

The anhydrous ash content of the samples was determined in accordance with the DIN 51719 standard by thermogravimetric analysis as follows: Before weighing-in, the sample was ground or mortared. Prior to ash determination, the dry matter content of the weighed-in material was determined. The sample material was weighed into a crucible to the nearest 0.1 mg. The furnace, including the sample, was heated to a target temperature of 815° C. at a heating rate of 9° K/min and then held at this temperature for 2 h. The furnace was then cooled down to 300° C. before the samples were removed. The ash content was determined. The samples were cooled to ambient temperature in the desiccator and reweighed. The remaining ash was related to the sample weight to determine the ash content by weight. Triplicate determinations were made for each sample and the averaged value reported.

### 3. Determination of the pH Value of the Organic Fillers

The pH value was determined in accordance with ASTM D 1512 as follows. The dry sample, if not already available as powder, was mortared or ground to a powder. In each case, 5 g of sample and 50 g of fully ionized water were weighed into a beaker. The suspension was heated to a temperature of 60° C. with constant stirring using a magnetic stirrer with heating function and magnetic agitator, and the temperature was maintained at 60° C. for 30 min. Subsequently, the heating function of the stirrer was deactivated so that the batch could cool down while stirring. After cooling, the evaporated water was replenished by adding fully deionized water again and stirred again for 5 min. A calibrated meter was used to determine the pH of the suspension. The temperature of the suspension was to be 23° C. (±0.5° C.). A duplicate determination was performed for each sample and the averaged value was reported.

### 4. Determination of the ¹⁴C Content

The determination of the ¹⁴C content (biobased carbon content) can be carried out using the radiocarbon method according to DIN EN 16640:2017-08.

### 5. Determination of the Carbon Content

The carbon content can be determined by elemental analysis according to DIN 51732:2014-7.

### 6. Determination of the Oxygen Content

The oxygen content can be determined by elemental analysis according to DIN 51732:2014-7. In the process, the CHNS content is determined by means of the abovementioned analysis, and the oxygen is subsequently calculated as the difference (100-CHNS).

### 7. Determination of the Particle Size Distribution

The grain size distribution can be determined by laser diffraction of the material dispersed in water according to ISO 13320:2020-01. The volume fraction is specified, for example, as d99 in μm (diameter of the grains of 99% of the volume of the sample is below this value).

### 8. Determination of Solubility in Alkaline Media

The determination of alkali solubility is performed as follows:

The solubility is determined in triplicate. For this purpose, 2.0 g dry filler are weighed into 20 g 0.1 M NaOH each. If, however, the determined pH of the sample is <10, this sample is discarded and 2.0 g dry filler is weighed into each 20 g 0.2 M NaOH instead. Thus, depending on the pH (<10 or ≥10), either 0.1 M NaOH is used (pH ≥10) or 0.2 M NaOH (pH<10). The alkaline suspension is shaken at room temperature for 2 hours at a shaker speed of 200 per minute. In order to avoid the liquid touching the lid during this process, the shaker speed is lowered to an extent so that this does not happen. The alkaline suspension is then centrifuged at 6000 g. The supernatant from the centrifugation is removed and is filtered through a Por 4 frit. The solid after centrifugation is washed twice with distilled water, and the above described centrifugation and filtration steps are repeated after each wash. The solid is dried for at least 24 h at 105° C. in a drying oven until constant weight. The alkaline solubility of the solid is calculated as follows:

Alkaline solubility solid [%]=mass of undissolved fraction after centrifugation, filtration and drying [g]*100/mass of starting product [g].

### 9. ¹³C Solid State NMR

¹³C solid state NMR (SSNMR) spectra were obtained with a Bruker 9.4 T (operating at 400.34 MHz for 1H, and at 100.67 MHZ for ¹³C) Avance III HD 400 spectrometer equipped with a 4 mm magic angle spinning (MAS) probe. ¹³C Cross Polarization (CP) MAS measurements were conducted at a spinning rate of 14 kHz, with a 90° pulse for ¹H of 2.4 μs and a contact time of 2 ms. ¹³C spectra were internally referenced by the chemical shift of methoxy peak of the lignin (δ=56.1 ppm) and acquired with 1486 complex points with a spectral width of 295 ppm, with a relaxation delay of 2 s, and acquired with a maximum of 30000 averages, with sufficient signal-to-noise ratio being ensured.

### 10. Determination of the Sulfur Content

The sulfur content can be determined by elemental analysis according to DIN 51724-1:2012-7.

### 11. Evaluation of Mechanical Properties

The vulcanizates for tensile tests were cured in sheets of 90×90×2 mm³ in the Wickert laboratory press for 30 minutes. For the tensile tests, the vulcanized sheets were die-cut to dumbbell shaped specimens. The tests were performed in a Zwick Z020 Universal Tensile Tester at a crosshead speed of 500 mm/min, according to ISO 37, method A. Five specimens were used for the evaluation of the tensile data. The mean values taken from these five specimens are reported.

### 12. Determination of Compound Hardness

The hardness of the samples was measured with a Zwick 3150 hardness tester, Shore A type according to ISO 48 at 23° C. The tests were carried out using cylindrical specimens of 6 mm thickness prepared for 30 minutes.

### EXAMPLES

The following examples further illustrate the invention but are not to be construed as limiting its scope.

### 1. Preparation of Organic Fillers

### 1.1 Organic Filler Precursor FPM1

A lignin FPM1 obtainable by hydrothermal treatment was used as organic filler precursor material. Lignin FPM1 obtainable by hydrothermal treatment was prepared analogously to the process described in WO 2017/085278 A1 for the preparation of lignins obtainable by hydrothermal treatment.

For this purpose, a liquid containing the renewable raw material is provided. First, water and lignin are mixed and a lignin-containing liquid with an organic dry matter content of 15% by weight is prepared. The lignin is then completely dissolved in the lignin-containing liquid. For this purpose, the pH is adjusted to 9.8 by adding NaOH. The preparation of the solution is assisted by intensive mixing at 80° C. for 3 h. The lignin is then dissolved in the liquid. The liquid containing the renewable raw material is subjected to hydrothermal treatment to obtain a solid. In this process, the prepared solution is heated at 1.4 K/min to the reaction temperature of 220° C., which is maintained for a reaction period of 7 h. The solution is then cooled. As a result, an aqueous solid suspension is obtained. The solid is largely dewatered and washed by filtration and washing. The dewatered and washed solid is dried in a fluidized bed dryer to a residual moisture content of lower 3%. The dried solid is de-agglomerated to d99<20 μm on a NETZSCH steam jet mill under nitrogen. Subsequent thermal treatment is carried out under nitrogen in an oven, heating to the temperature of 230° C., holding for a period of 0.5 h and cooling again.

### 1.2 Organic Filler Precursor FPM2

A second lignin FPM2 obtainable by hydrothermal treatment was used, which was prepared analogously to the process described under section 1.1. The hydrothermal treatment was carried out in such a way that a liquid containing the renewable raw material is provided. First, water and lignin are mixed and a lignin-containing liquid with an organic dry matter content of 15% by weight is prepared. The lignin is then completely dissolved in the lignin-containing liquid. For this purpose, the pH is adjusted to 9.8 by adding NaOH. The preparation of the solution is assisted by intensive mixing at 80° C. for 3 h. The lignin is then dissolved in the liquid. The liquid containing the renewable raw material is subjected to hydrothermal treatment to obtain a solid. In this process, the prepared solution is heated at 1.4 K/min to the reaction temperature of 220° C., which is maintained for a reaction period of 7 h. The solution is then cooled. As a result, an aqueous solid suspension is obtained. The solid is largely dewatered and washed by filtration and washing. The dewatered and washed solid is dried and thermally treated in a fluidized bed dryer under nitrogen, whereby the material is heated to 50° C. at 1.5K/min for drying followed by an additional heat up to 190° C. at 1.5 K/min, holding for a period of 15 min and cooling again. The dried solid is de-agglomerated by grinding on an opposed jet mill under nitrogen to d99<10 μm. The milled solids are further treated in a ball mill under nitrogen followed by sieving using a 200 μm sieve.

### 1.3 Organic Filler Precursor FPM3

A third lignin FPM3 obtainable by hydrothermal treatment was used, which was prepared analogously to the process described under section 1.2. However, in deviation from the process described under section 1.2, the last step, i.e., the de-agglomeration by grinding and sieving was not carried out.
1.4 The lignins FPM1, FPM2 and FPM3 obtained by hydrothermal treatment were characterized by the above methods as indicated in Table 1.1 below. All three lignins had a ¹⁴C-content in a range of from 0.20 to 0.45 Bq/g of carbon.

TABLE 1.1
Properties of lignins FPM1, FPM2 and FPM3
obtained by hydrothermal treatment

| | | Lignin | Lignin | Lignin |
|---|---|---|---|---|
| Parameter | Unit | FPM1 | FPM2 | FPM3 |
| Single point BET | m² /g | 37 | 53.6 | 47.3 |
| d99 volume | μm | nd | 5.08 | 5.74 |
| fraction | | | | |
| Carbon content | Weight % | nd | 66.6 | 66.6 |
| Ash content | Weight % | nd | 3.71 | 3.71 |
| pH value | ./. | nd | 8.7 | 8.7 |
| Sulfur content | Weight % | nd | 0.96 | 0.96 |

nd = not determined

### 1.5 Organic Fillers According to the Invention

A number of organic fillers according to the invention were prepared, in each case using either the lignin FPM1 or FPM2 or FPM3 described above under sections 1.1 or 1.2 or 1.3 as starting material (precursor).

### Modifications of Lignin FPM1—Example OF1

2 g of lignin FPM1 and 8.46 mmol (50% of the molar amount of FPM1) 3-mercaptopropytriethoxysilane (MPTES) were weighed into a 100 mL round bottom flask. The resulting mixture was then heated to a temperature in the range of 160±5° C. for a period of 1 h. The resulting mixture was then transferred to a Soxhlet apparatus to extract solvent, unreacted MPTES and possible reaction by-products. The extraction was carried out using acetone for a period of 24 h. After extraction, the product obtained in each case was dried in an oven under vacuum at a temperature of 80° C. for a period of 24 h. OF1 had a BET surface area within the claimed range.

### Modifications of Lignin FPM2—Example OF2

20 g of lignin FPM2 and 16 mmol of 1,2-Bis(2-mercaptoethoxy)ethane (MEE) were weighed into a 100 mL round bottom flask further containing 50 ml of toluene. The resulting mixture was then heated to a temperature of 120° C. for a period of 1 h. The resulting mixture was then transferred to a Soxhlet apparatus to extract unreacted and/or physically adsorbed MEE and possible reaction by-products. The extraction was carried out using toluene for a period of 12 h. After extraction, the product obtained was dried in an oven under vacuum at a temperature of 80° C. for a period of 24 h. The resulting organic filler OF2 thus obtained was characterized by means of the above methods as indicated in Table 1.2 below.

### Modifications of Lignin FPM2—Example OF3

20 g of lignin FPM2 and 8 mmol of a liquid polysulfide polymer with three terminal SH-groups (LPST) having a weight average molecular weight (M_{w}) of 1016 g/mol were weighed into a 100 mL round bottom flask further containing 50 mL toluene. The resulting mixture was then heated to a temperature in the range of 120° C. for a period of 1 h. The resulting mixture was then transferred to a Soxhlet apparatus to extract solvent, unreacted and/or physically adsorbed LPST and possible reaction by-products. The extraction was carried out using toluene for a period of 12 h. After extraction, the product obtained was dried in an oven under vacuum at a temperature of 80° C. for a period of 24 h. The resulting organic filler OF3 thus obtained was characterized by means of the above methods as indicated in Table 1.2 below.

### Modifications of Lignin FPM3—Example OF4

20 g of lignin FPM3 and 16 mmol of 1,2-Bis(2-mercaptoethoxy)ethane (MEE) were weighed into a 100 mL round bottom flask further containing 50 ml of xylene. The resulting mixture was then heated to a temperature of 120° C. for a period of 3 h. The resulting mixture was then transferred to a Soxhlet apparatus to extract unreacted and/or physically adsorbed MEE and possible reaction by-products. The extraction was carried out using toluene for a period of 12 h. After extraction, the product obtained was dried in an oven under vacuum at a temperature of 80° C. for a period of 24 h. OF4 had a BET surface area within the claimed range.

### Modifications of Lignin FPM3—Example OF5

20 g of lignin FPM3 and 8 mmol of a liquid polysulfide polymer with three terminal SH-groups (LPST) having a weight average molecular weight (M_{w}) of 1016 g/mol were weighed into a 100 mL round bottom flask further containing 50 mL xylene. The resulting mixture was then heated to a temperature in the range of 120° C. for a period of 3 h. The resulting mixture was then transferred to a Soxhlet apparatus to extract solvent, unreacted and/or physically adsorbed LPST and possible reaction by-products. The extraction was carried out using toluene for a period of 12 h. After extraction, the product obtained was dried in an oven under vacuum at a temperature of 80° C. for a period of 24 h. OF5 had a BET surface area within the claimed range.

TABLE 1.2
Properties of lignins OF2 and OF3

| | | Lignin | Lignin |
|---|---|---|---|
| Parameter | Unit | OF2 | OF3 |
| BET | m² /g | 48.7 | 45.6 |
| Ash content | Weight % | 4.69 | 4.85 |
| Sulfur content | Weight % | 1.53 | 1.48 |

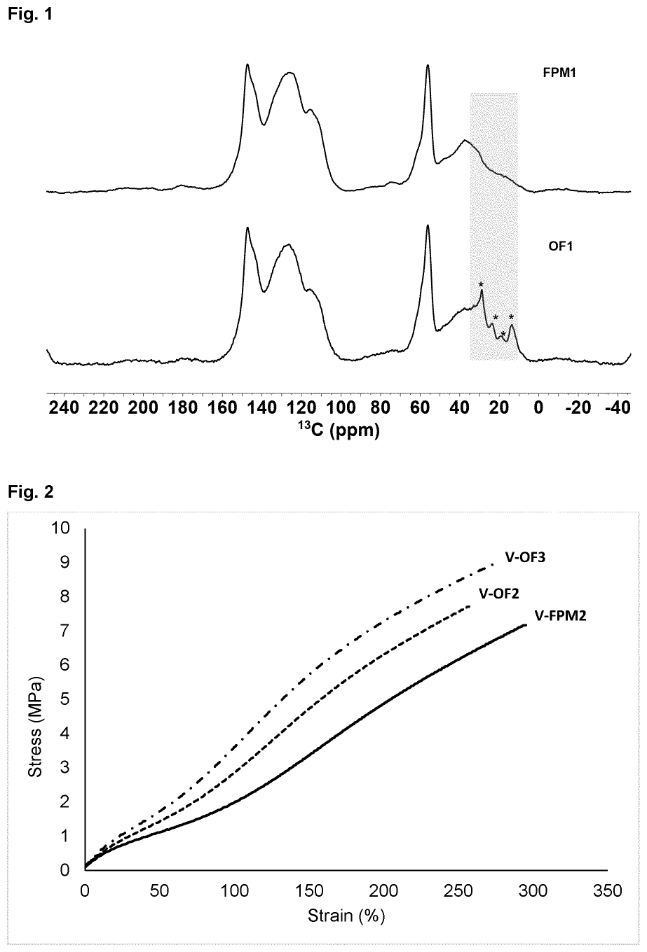

The organic fillers were further investigated by ¹³C NMR spectroscopy. As it is evident from FIG. 1 compared to FPM1 (a) in FIG. 1) additional peaks (represented by symbol) are observed for OF1 samples (c) in FIG. 1) in the region between 10-35 ppm. These represent aliphatic chain carbons and correspond to the characteristic signals of MPTES chemically grafted to the lignin surface. Hence, the —S—C₃H₆—Si(OC₂H₅)₃— residue of MPTES has been chemically bonded to OF1 as sulfur atom-containing organic residue at least in part to the aliphatic carbon atoms of OF1 by partial substitution of the OH-groups formerly present at these carbon atoms.

### 1.6 Further Investigations Based on Model Substances

Further studies based not on any of organic fillers FPM1 or FPM2 but on two model substances, namely VA (vanillyl alcohol) and G (guaiacol) have been performed as proof-of-concept studies, which show that the sulfur atom-containing organic residue to be introduced into the chemical structure of the filler is indeed covalently bonded to an aliphatic carbon atom formerly bearing an OH-group and not at any other position. VA (vanillyl alcohol) and G (guaiacol) are simplified lignin representative structures, with either phenolic (G) or a combination of phenolic and aliphatic hydroxyl functional groups (VA), both being in general susceptible to modifications.

For these studies, equimolar quantities (3 mmol) of VA or G and MPTES were taken in a 5 ml ampoule. The vial containing the reaction mixture was immersed into an oil bath at 160±5° C. and reaction was carried for an hour under continuous stirring. Then, the reaction was stopped immediately by quenching the vial in liquid nitrogen. The obtained products in each case were then investigated inter alia by liquid state NMR 1D- and 2D-NMR, through which correlations were used to unambiguously identify the different products, by one bond ¹³C-¹H coupling (HSQC), or multiple bond ¹³C-¹H coupling (HMBC).

It was found that upon reaction of VA and MPTES the presence of the aliphatic hydroxy carbon (formerly present in VA) could no longer detected by the NMR techniques used. Instead, it was found that the —S—C₃H₆—Si(OC₂H₅)₃-residue of MPTES has been chemically bonded to VA as sulfur atom-containing organic residue, namely to the aliphatic carbon atom of VA, which formerly was substituted with an OH-group, i.e., by substitution of the aliphatic OH-group, in a quantitative manner. No remaining sulfur signals of MPTES could be detected. It was further found that upon reaction of G and MPTES no reaction with MPTES occurred at all. Only sulfur signals of MPTES could be detected.

### 2. Preparation of Vulcanizable and Vulcanized Rubber Compositions

Rubber compositions with the ingredients and amounts given in Tables 2.1 and 2.2 were prepared as follows. In particular, rubber compositions containing one of FPM2, OF2 and OF3 (Table 2.1) as well as FPM3, OF4 and OF5 (Table 2.2) have been prepared. The amounts/numbers indicated in Tables 2.1 and 2.2 are in each case phr.

TABLE 2.1
Rubber compositions R-FPM2, R-OF2 and R-OF3

| | R-FPM2 | R-OF2 | R-OF3 |
|---|---|---|---|
| Ingredients | (comparative) | (inventive) | (inventive) |
| SSBR-4601 | 100 | 100 | 100 |
| Filler | 40 (FPM2) | 46 (OF2) | 56 (OF3) |
| TDAE | 4 | 4 | 4 |
| ZnO | 3 | 3 | 3 |
| Stearic Acid | 2 | 2 | 2 |
| Sulfur | 2 | 2 | 2 |
| TBBS | 1.2 | 1.2 | 1.2 |
| TBzTD | 0.3 | 0.3 | 0.3 |

TABLE 2.2
Rubber compositions R-FPM3, R-OF4 and R-OF5

| | R-FPM3 | R-OF4 | R-OF5 |
|---|---|---|---|
| Ingredients | (comparative) | (inventive) | (inventive) |
| SSBR-4601 | 100 | 100 | 100 |
| Filler | 40 (FPM3) | 40 (OF4) | 40 (OF5) |
| TDAE | 4 | 4 | 4 |
| ZnO | 3 | 3 | 3 |
| Stearic Acid | 2 | 2 | 2 |
| Sulfur | 2 | 2 | 2 |
| TBBS | 1.2 | 1.2 | 1.2 |
| TBzTD | 0.3 | 0.3 | 0.3 |

SSBR-4601 is a commercially available SSBR rubber. TDAE is a commercially available aromatic mineral oil. TBBS is N-tert-butyl-2-benzothiazolesulfenamide. TbzTD is tetrabenzylthiuram disulfide. ZnO is zinc oxide.

Two stage mixing was performed using a tangential rotor internal mixer with a chamber volume of 50 cm³ (Brabender Plasticorder). For stage 1 mixing (masterbatch preparation) the mixer was operated at a fill factor of 70%, a rotor speed of 50 rpm and an initial set temperature of 50° C. till the ram sweep at 2:00. All the ingredients were added within 2 minutes. Thereafter, the rotor speed was varied in order to achieve the desired discharge temperature and the compounds were mixed for 6 minutes.

| Time (min:sec) | Action |
|---|---|
| 0.00-2.00 | Add rubber, filler, ZnO, stearic acid, TDAE |
| 2.00-6.00 | Mix and dump at a temperature between |
| | 95° C. and 170° C. |

The stage 2 mixing: addition of remaining ingredients, was also carried out in the Brabender Plasticorder operated at a fill factor of 70%, a rotor speed of 30 rpm and an initial set temperature of 50° C. After the compounds were discharged, they were sheeted out on the two-roll mill operating with a gap width of 2.5 mm.

### 3. Properties of the Vulcanized Rubber Compositions

The properties of the vulcanized rubber compositions according to the invention V-OF2, V-OF3, V-OF4 and V-OF5 and the vulcanized rubber compositions used as comparative examples V-FPM2 and V-FPM3 were determined according to the test methods described above.

As it is evident from FIG. 2 use of organic fillers OF2 and OF3 with thioether linkages as fillers in rubber compositions V-OF2 and V-OF3 improved mechanical properties in terms of tensile strength compared to having used organic filler FPM2 without thioether linkages in reference sample V-FPM2. This shows that the addition of OF2 and OF3 results in a better filler-rubber interaction than FPM2.

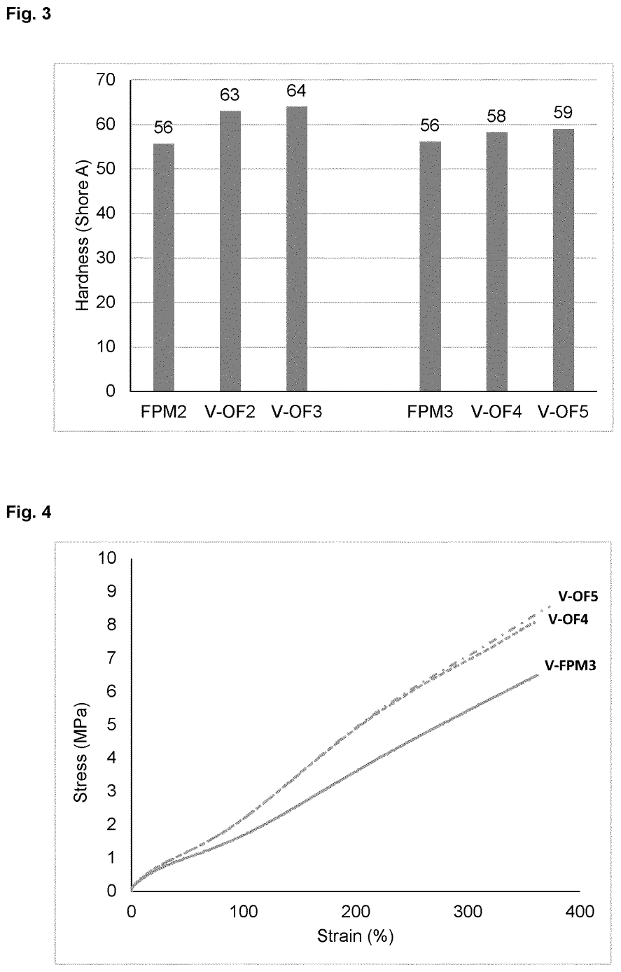

As it is evident from FIG. 3 use of organic fillers OF2 and OF3 also showed an improved hardness of the vulcanized rubber compositions compared to having used organic filler FPM2.

Even when using the same relative proportions, here e.g., 40 phr, of fillers OF4 and OF5 in the respective vulcanizable rubber compositions V-OF4 and V-OF5, the results obtained with the fillers with thioether linkage according to the invention show a clear improvement in the mechanical properties compared with a reference sample V-FPM3 in which no filler with thioether linkage was used (FIG. 4). And also in this case, the use of the fillers according to the invention shows an improved hardness compared to the comparative sample (FIG. 3).

1. An organic filler comprising a ¹⁴C-content in a range of from 0.20 to 0.45 Bq/g of carbon and a BET surface area in a range of 10 to <200 m²/g,
wherein at least a part of the hydroxyl groups being present in the chemical structure of the organic filler, which are bonded to at least one aliphatic carbon atom, has been substituted with a covalently bonded sulfur atom(s)-containing organic residue, wherein at least one sulfur atom is adjacent to a carbon atom within said organic residue, such that aliphatic carbon-sulfur-carbon linkages in the chemical structure of the organic filler have been formed and are present.

2. The filler of claim 1, wherein the hydroxyl groups of the organic filler, which are bonded to the at least one aliphatic carbon atom, are hydroxyl groups being attached to an aliphatic residue comprising the at least one aliphatic carbon atom and wherein the sulfur atom(s)-containing organic residue is a divalent organic residue, within which at least one sulfur atom is positioned adjacently to an aliphatic carbon atom, such that aliphatic carbon-sulfur-aliphatic carbon linkages in the chemical structure of the organic filler have been formed and are present therein.

3. The filler of claim 1, wherein the aliphatic carbon-sulfur-carbon linkages in the chemical structure have been introduced by a reaction of at least part of the hydroxyl groups being bonded to at least one aliphatic carbon atom with at least one organic modification agent, which comprises at least one thiol group being positioned adjacently to a carbon atom within its chemical structure, wherein at least part of these hydroxyl groups have been replaced with a covalently bonded sulfur atom(s)-containing organic residue, wherein at least one sulfur atom present therein originates from the thiol group of the organic modification agent.

4. The filler of claim 1, wherein the carbon atom being positioned adjacently to the sulfur atom of the covalently bonded sulfur atom-containing organic residue is not part of an unsubstituted and/or saturated hexyl group.

5. The filler of claim 1, wherein hydroxyl groups are still present in the chemical structure of the organic filler, which are bonded to at least one aliphatic carbon atom, in particular since only a part of these hydroxyl groups has been substituted with the covalently bonded sulfur atom(s)-containing organic residue.

6. The filler of claim 1, further comprising at least one kind of functional groups selected from aromatic hydroxyl groups, and carboxylic acid groups including carboxylate groups.

7. The filler of claim 1, wherein the filler is a lignin-based filler.

8. The filler of claim 1, wherein the aliphatic carbon-sulfur-carbon linkages in the chemical structure have been introduced by a reaction of at least part of the hydroxyl groups being bonded to at least one aliphatic carbon atom with at least one organic modification agent,
which is at least one thiol of general formula (I), 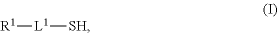
wherein L¹ is selected from C₂₋₃₀ alkylene groups, C₂₋₃₀ heteroalkylene groups, C₃₋₃₀ alkenylene groups, C₂₋₃₀ heteroalkenylene groups, C₃₋₃₀ alkynylene groups and C₂₋₃₀ heteroalkynylene groups, wherein one or more hydrogen atoms of any of these groups are optionally and/or independently of each other replaced by at least one of fluorine, hydroxyl groups and/or O—C₁₋₄ alkyl groups, and R¹ is an OH-group, an O—C₁₋₄ alkyl group, an SH-group an S—C₁₋₄ alkyl group, a C(═O)OR¹¹ group, an NR¹¹R¹² group, an NR¹¹C(═O)NR¹²R¹³ group, an NR¹¹C(═O)OR¹², an OC(═O)NR¹¹R¹² group, an S(═O)₂NR¹¹ group, an OPO₃²⁻ group or salts thereof, an OC(═O)O group or salts thereof, a C(NR¹¹)R¹² group, an NR¹¹CNR¹²NR¹³R¹⁴ group, a C(═O)SR¹¹ or a C(═S)OR¹¹ group, or a halide, wherein R¹¹, R¹², R¹³ and R¹⁴ are independently selected from H, C₁₋₈ alkyl, C₁₋₈ alkenyl and C₁₋₈ alkynyl,
and/or
which is at least one thiol of general formula (II), 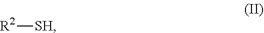
wherein R² is a C₁₋₃₀ hydrocarbon group, which may optionally contain one or more heteroatoms and/or heteroatom groups, wherein the heteroatoms are selected from O, S and N, and wherein the heteroatom groups are selected from NH, and NR with R being a C₁₋₄ aliphatic residue, preferably a C₇₋₃₀ hydrocarbon group, in each case wherein one or more hydrogen atoms are optionally and/or independently of each other replaced by at least one of fluorine, hydroxyl groups and/or O—C₁₋₄ alkyl groups,
and/or
which is at least one thiol of general formula (III), 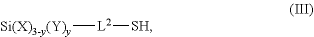
wherein y is an integer from 0 to 3,
wherein Y is a non-hydrolyzable organic residue, or represents a residue L²-SH,
wherein X is in each case independently of one another represents a hydrolyzable group, which is reactive with at least one of phenolic OH-groups, phenolate groups, aliphatic OH-groups, carboxylic acid groups, carboxylate groups, silyl ether groups and mixtures thereof,
wherein L² is a divalent non-hydrolyzable organic residue selected from C₁₋₃₀ alkylene groups, wherein in each case one or more hydrogen atoms are optionally and/or independently of each other replaced by at least one of fluorine and O—C₁₋₄ alkyl
and/or
which is at least one thiirane of general formula (IV) as thiol-precursor, 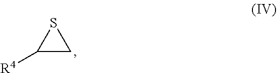
wherein R⁴ is a C₁₋₃₀ hydrocarbon group, which may optionally contain one or more heteroatoms and/or heteroatom groups, wherein the heteroatoms are preferably selected from O, S and N, and wherein the heteroatom groups are selected from NH, and NR with R being a C₁₋₄ aliphatic residue, preferably a C₇₋₃₀ hydrocarbon group, in each case wherein one or more hydrogen atoms are optionally and/or independently of each other replaced by at least one of fluorine, hydroxyl groups and/or O—C₁₋₄ alkyl groups,
and/or
which is at least one polymeric polythiol having at least two or more terminal thiol-groups.

9. The filler of claim 1, wherein the filler is obtainable by carrying out at least one step a) and optionally one or more of steps b) to d),
a) bringing together at least one organic modification agent, which comprises at least one thiol group being positioned adjacently to a carbon atom within its chemical structure, and at least one organic filler precursor FPM having a ¹⁴C content in a range of from 0.20 to 0.45 Bq/g carbon, having a BET surface area in a range of 10 to <200 m²/g, and having at least one hydroxyl group bonded to at least one aliphatic carbon atom,
b) optionally heating the mixture obtained according to step a), which is present within a liquid or gaseous reaction medium, to a temperature in a range from 30° C. to 190° C.,
c) optionally extracting at least one organic solvent, in case step a) and/or the optional heating according to step b) have been carried out in a liquid reaction medium containing at least one organic solvent, after at least a part of the hydroxyl groups, which are bonded to at least one aliphatic carbon atom of the organic filler precursor FPM, has been substituted with a covalently bonded sulfur atom(s)-containing organic residue, wherein at least one sulfur atom present therein originates from the thiol group of the organic modification agent, and
d) optional drying of the organic filler obtained after carrying out step a) and optionally step b) and/or c), under vacuum and/or at a temperature in a range from 20 to 100° C.

10. The filler of claim 1, wherein the filler is in rubber-free form.

11. A rubber composition comprising at least one rubber and at least one filler component,
wherein the filler component comprises at least one organic filler according to claim 1
and/or
wherein the filler component comprises (i) at least one organic filler precursor FPM having a ¹⁴C content in a range of from 0.20 to 0.45 Bq/g carbon, having a BET surface area in a range of 10 to <200 m²/g, and having at least one hydroxyl group bonded to at least one aliphatic carbon atom, and (ii) at least one organic modification agent, which comprises at least one thiol group being positioned adjacently to a carbon atom within its chemical structure, by means of which a covalent bond to the at least one organic filler precursor FPM can be formed through at least partial substitution of the hydroxyl groups being present in the chemical structure of the organic filler precursor FPM, which are bonded to at least one aliphatic carbon atom, with a covalently bonded sulfur atom(s)-containing organic residue such that aliphatic carbon-sulfur-carbon linkages in the chemical structure of the organic filler are generated, wherein at least one sulfur atom present therein originates from the thiol group of the organic modification agent, and an organic filler according to one or more of the preceding claims is formed.

12. The rubber composition of claim 11, wherein said at least one rubber is selected from the group consisting of natural rubber (NR), halobutyl rubbers, butyl rubber or isobutylene-isoprene rubber, styrene-butadiene rubber, polybutadiene, acrylonitrile-butadiene rubbers and/or hydrogenated acrylonitrile-butadiene rubber, chloroprene, polyisoprene, ethylene-propylene-diene rubber, and mixtures thereof,
and/or
wherein the at least one organic filler is present in an amount ranging from 10 to 150 phr, and/or the at least one organic filler precursor FPM is present in an amount which is in a range from 10 to 150 phr, and the at least one organic modification agent is present in an amount which is in a range from 0.1 to 30 wt. %, in each case based on the total weight of the organic filler precursor FPM.

13. A vulcanizable rubber composition comprising the rubber composition of claim 11 and a vulcanization system comprising at least zinc oxide and/or at least sulfur or a sulfur donor and/or at least one peroxide.

14. A kit-of-parts comprising, in spatially separated form, a rubber composition as part (A) as defined in claim 11 and a vulcanization system as part (B) as defined in claim 13.

15. A vulcanized rubber composition which is obtainable by vulcanizing the vulcanizable rubber composition of claim 13 or by vulcanizing a vulcanizable rubber composition obtainable by combining and mixing the two parts (A) and (B) of the kit-of-parts of claim 14.

16. A method of producing rubber compositions, the method comprising
preparing the organic filler of claim 1; and
mixing the organic filler with at least one rubber selected from the group consisting of natural rubber (NR), halobutyl rubbers, butyl rubber or isobutylene-isoprene rubber, styrene-butadiene rubber, polybutadiene, acrylonitrile-butadiene rubbers and/or hydrogenated acrylonitrile-butadiene rubber, chloroprene, polyisoprene, ethylene-propylene-diene rubber, and mixtures thereof to form the rubber composition.

17. The method of claim 16, further comprising vulcanizing the rubber composition with a vulcanization system comprising one or more of zinc oxide, sulfur, a sulfur donor, at least one peroxide.

18. The rubber composition of claim 12, wherein the rubber composition comprises the organic filler in an amount in a range of from 15 to 130 phr, and the at least one organic filler precursor FPM is present in an amount in a range of from 15 to 130 phr, and the at least one organic modification agent is present in an amount in a range of from 0.5 to 25 wt. %, in each case based on the total weight of the organic filler precursor FPM.

19. The filler of claim 2, wherein the hydroxyl groups of the organic filler are primary hydroxyl groups attached to a C₁₋₃ aliphatic or C₄₋₆ heterocycloaliphatic residue.

20. The filler of claim 2, wherein the hydroxyl groups of the organic filler are primary hydroxyl groups attached to a C₃ aliphatic or C₆ heterocycloaliphatic residue.
